(19) United States
(12) Patent Application Publication
(10) Pub. No.: US 2009/0240047 A1
(43) Pub. Date: Sep. 24, 2009

(54) CELLULOSIC RESIN FILM AND PROCESS FOR PRODUCING THE SAME

(75) Inventor: Masahiko Noritsune, Shizuoka (JP)

Correspondence Address: YOUNG & THOMPSON, 209 Madison Street, Suite 500, ALEXANDRIA, VA, 22314, US

(73) Assignee: Fujifilm Corporatio, Tokyo (JP)

(21) Appl. No.: 12/297,687

(22) PCT Filed: Apr. 18, 2007
(86) PCT No.: PCT/JP2007/058407

§ 371 Date: Oct. 20, 2008

(30) Foreign Application Priority Data
Apr. 19, 2006 (JP) 2006-115831

(51) Int. Cl. B29C 47/88; C08B 15/00

(52) U.S. Cl. 536/56; 264/211.12

(57) ABSTRACT

The invention provides a melt-casting film formation process for a cellulosic resin film, by which thickness unevenness of the cellulosic resin film is suppressed in both the cross-machine direction and machine direction. Consequently the invention can provide a cellulosic resin film having high optical properties. In this process for producing the cellulosic resin film, a resin molten in an extruder (22) is extruded through a die (24) onto a rotating chill roll (28) which chills and solidifies the resin to a film (12′), in which temperature difference in the cross-machine direction of the resin sheet (12) from departing the die (24) to touching the chill roll (28) is regulated within 10° C.

### TECHNICAL FIELD

The present invention relates to a cellulosic resin film and a process for producing the same, and especially relates to a cellulosic resin film having the quality suitable for a liquid crystal display device and a process for producing such film.

### BACKGROUND ART

A cellulosic resin film has been used as means for enlarging a viewing angle by stretching a cellulosic resin film to generate in-plane retardation (Re) and thickness-direction retardation (Rth) and utilizing the same as a retardation film for a liquid crystal display element.

Methods for stretching a cellulosic resin film include a method stretching in the longitudinal (length) direction of the film (machine direction stretching), a method stretching in the traverse (width) direction of the film (cross-machine direction stretching), and a method conducting simultaneously both machine direction stretching and cross-machine direction stretching (simultaneous stretching). Among them the machine direction stretching has been most frequently conducted owing to the compactness of a facility therefor. In general the machine direction stretching is a method to stretch a film in the longitudinal direction by heating the film between 2 or more pairs of nip rolls beyond the glass transition temperature (Tg) and making the transportation speed of the outlet nip rolls larger than the transportation speed of the inlet nip rolls.

A method of machine direction stretching of a cellulose ester is described in Patent Document 1. According to Patent Document 1, the direction of machine direction stretching is reversed from the direction of a casting film formation in order to improve the angle fluctuation of the slow axis. A stretching method using nip rolls installed in a narrow span of the length width ratio (L/W) from 0.3 to 2 installed in a stretching zone is described in Patent Document 2. According to Patent Document 2, the thickness-direction orientation (Rth) can be improved. Thereby the length width ratio means the quotient of the distance (L) between nip rolls to be used for stretching divided by the width (W) of a film to be stretched.

### Patent Document 1: Japanese Patent Application Laid-Open No. 2002-311240

### Patent Document 2: Japanese Patent Application Laid-Open No. 2003-315551

In case an unstretched (before stretching) cellulosic resin film is formed by a melt-casting film formation method, there is a problem of difficulty in leveling due to the high melt viscosity of a cellulosic resin film. Consequently there arises a problem that a cellulosic resin film formed by the melt-casting film formation method may have higher unevenness in thickness in a cross-machine direction and in a longitudinal direction (a flow direction of the resin sheet extruded from the die).

Under such circumstances the present invention has been contemplated with an object to provide a cellulosic resin film that can obtain a good optical properly film, and a process for producing the same by suppressing development of the thickness unevenness in the cross-machine direction and machine direction.

### DISCLOSURE OF THE INVENTION

In order to accomplish the object, the first aspect of the present invention is a process for producing a cellulosic resin film by extruding a molten resin molten in an extruder in a form of a sheet through a die onto a rotating chill roll to chill and solidify the resin forming a film, characterized in that the film is formed by keeping a temperature difference in the cross-machine direction of the resin sheet from departing the die to touching the chill roll within 10° C.

The inventors of the present invention have studied a method to suppress the thickness unevenness of the produced cellulosic resin film to obtain a finding that the thickness unevenness can be suppressed by forming the film keeping a temperature difference in the cross-machine direction of the resin sheet from departing the die to touching the chill roll within 10° C.

Consequently according to the first aspect of the present invention, in a process for producing a cellulosic resin film by extruding a molten resin molten in an extruder in a form of a sheet through a die onto a rotating chill roll to chill and solidify the resin forming a film, and by forming the film keeping a temperature difference in the cross-machine direction of the resin sheet from departing the die to touching the chill roll within 10° C., development of the thickness unevenness especially in the cross-machine direction among various directions can be suppressed to obtain a cellulosic resin film having uniform optical properties suitable for an optical end use. Thereby the temperature difference in the cross-machine direction means the difference between the maximum and minimum temperatures of a resin sheet in the cross-machine direction.

The second aspect of the present invention is the process according to the first aspect of the present invention, characterized in that the film is formed by keeping a temperature decrease in the machine direction of the resin sheet from departing the die to touching the chill roll within 20° C.

According to the second aspect of the present invention, by forming the film keeping a temperature decrease in the machine direction of the resin sheet from departing the die to touching the chill roll within 20° C., development of the thickness unevenness in the film can be further suppressed. The second aspect of the present invention is especially effective against thickness unevenness in the machine direction of the film among various directions. Thereby the temperature decrease in the machine direction means the difference between the temperature of the molten resin at departing the die minus the temperature at touching the chill roll.

The third aspect of the present invention is the process according to the first or the second aspect of the present invention, characterized in that at least one side of the resin sheet from departing the die to touching the chill roll is heated by a heating unit, wherein a heated length by the heating unit in the machine direction of the resin sheet is 20% or more of the machine direction length of the resin sheet from departing the die to touching the chill roll.

According to the third aspect of the present invention, by heating at least one side of the resin sheet from departing the die to touching the chill roll by the heating unit and by making the length of the heating unit in the machine direction of the resin sheet to 20% or more of the machine direction length of the resin sheet from departing the die to touching the chill roll, the temperature difference in the cross-machine direction of the resin sheet can be made within 10° C., and further the temperature decrease in the machine direction of the resin sheet can be made within 20° C. Consequently, development of the thickness unevenness of the film can be suppressed so that a cellulosic resin film having uniform optical properties suitable for an optical end use can be obtained.

The fourth aspect of the present invention is the process according to the third aspect of the present invention, characterized in that the machine direction length of the resin sheet from departing the die to touching the chill roll is 200 mm or shorter.

According to the fourth aspect of the present invention, by limiting the machine direction length of the resin sheet from departing the die to touching the chill roll to 200 mm or shorter, the temperature control in the cross-machine direction and a machine direction becomes easy and development of the thickness unevenness of the cellulosic resin film can be suppressed.

The fifth aspect of the present invention is the process according to the third or the fourth aspect of the present invention, characterized in that heating temperatures of the heating unit in the cross-machine direction of the resin sheet can be controlled.

According to the fifth aspect of the present invention, by acquiring the capability of controlling the heating temperatures of the heating unit in the cross-machine direction of the resin sheet, the thickness unevenness in the cross-machine direction among various directions can be suppressed.

The sixth aspect of the present invention is the process according to any one of the third to the fifth aspects of the present invention, characterized in that the resin sheet and the heating unit are sheathed by a cover having a heat-insulation function and/or a heat-reflection function.

According to the sixth aspect of the present invention, by sheathing the resin sheet from departing the die to touching the chill roll and the heating unit by a cover having a heat-insulation function and/or a heat-reflection function, the temperature difference in the cross-machine direction of the resin sheet can be efficiently suppressed, and development of the thickness unevenness of the film can be suppressed.

The seventh aspect of the present invention is the process according to any one of the first to the sixth aspects of the present invention, characterized in that the resin sheet is nipped for chilling and solidifying to form a film between a pair of rolls, one of which is the chill roll and the other is an elastic roll.

According to the seventh aspect of the present invention, the resin sheet extruded through the die is chilled and solidified under nipping by a pair of rolls, a streaking trouble can be prevented and the thickness accuracy can be further improved.

The eighth aspect of the present invention is a cellulosic resin film characterized by being produced by the process according to any one of the first to seventh aspects of the present invention.

According to the present invention, the thickness unevenness can be suppressed, and therefore a cellulosic resin film with good optical properties can be obtained.

According to the present invention, the development of the thickness unevenness of a cellulosic resin film in the cross-machine direction and in the machine direction can be suppressed, and therefore the present invention can provide a cellulosic resin film that can obtain a good optical property film, and a process for producing the same.

### BRIEF DESCRIPTION OF THE DRAWINGS

FIG. 1 is a diagram of the constitution of a film producing equipment according to the present invention;

FIG. 2 is a schematic diagram of the constitution of an extruder;

FIG. 3 is a perspective diagram of a film formation process section;

FIG. 4 is a schematic diagram of a pair of metallic rolls in the film formation process section;

FIG. 5 is a schematic diagram of another embodiment of the film formation process section;

FIG. 6 is a perspective diagram of another embodiment of the film formation process section;

FIG. 7 is a schematic diagram of another embodiment of the film formation process section;

FIG. 8 is a diagram of the constitution of a film producing equipment of another embodiment according to the present invention;

FIG. 9 is a schematic diagram of another embodiment of the film formation process section;

FIG. 10 is a perspective diagram of another embodiment of the film formation process section;

FIG. 11 is an explanatory drawing of examples of the present invention; and

FIG. 12 is an explanatory drawing of examples of the present invention.

### DESCRIPTION OF SYMBOLS

10, 10′ . . . film producing equipment, 12 . . . resin sheet, 12′ . . . cellulose acylate film, 14 . . . film formation process section, 20 . . . winding process section, 22 . . . extruder, 24 . . . die, 24a . . . die lip, 25 . . . heating unit, 25a . . . heater, 26 . . . roll (an elastic roll), 27, . . . cover, 28 . . . roll (a chill roll), 28′ . . . casting roll, 44 . . . metallic sheath (an external cylinder), 46 . . . liquid medium layer, 48 . . . elastic layer (an internal cylinder), 50 . . . metallic shaft, E . . . length of a heating unit, F . . . length of a molten resin in the machine direction, Q . . . length of a contact zone, Y . . . casted film speed, Z . . . wall thickness of the external cylinder

### BEST MODE FOR CARRYING OUT THE INVENTION

Preferable embodiments of a cellulosic resin film and a process for producing the same according to the present invention will be explained by means of the attached drawings. Although production of a cellulose acylate film is exemplified in the current embodiment, the present invention is not limited thereto and applicable to production of cellulosic resin films other than the cellulose acylate film. Further in the current embodiment a film formation by the touch roll process, in which an extruded resin is cooled while being nipped by a pair of rolls including a touch roll in a form of a metallic elastic roll, is explained without limited thereto.

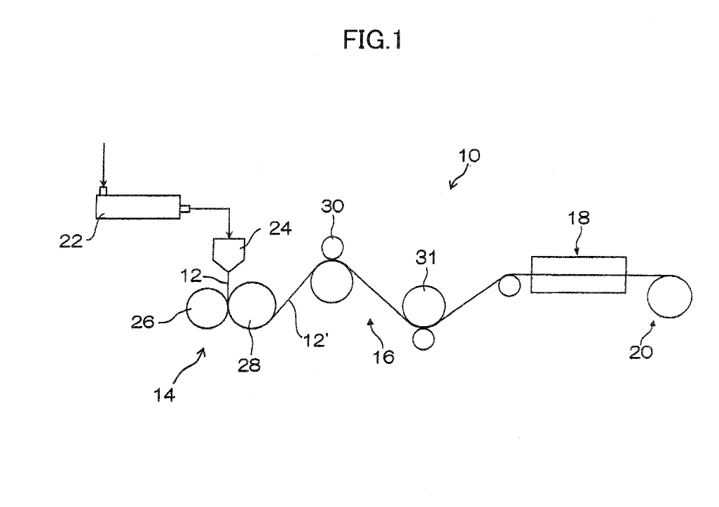

FIG. 1 illustrates an example of an outline constitution of a producing equipment for a cellulose acylate film. As shown in FIG. 1, the film producing equipment 10 are composed substantially of a film formation process section 14, in which a unstretched cellulose acylate film 12′ is produced, a machine direction stretching process section 16, in which the cellulose acylate film 2′ produced in the film formation process section 14 is stretched in the machine direction, a cross-machine direction stretching process section 18 for stretching in the cross-machine direction, and a winding process section 20, in which a stretched cellulose acylate film 12′ is wound to a reel.

In the film formation process section 14, a cellulose acylate resin molten in an extruder 22 is extruded through the die 24 in a sheet form, and fed between a pair of rotating rolls 26, 28. The cellulose acylate film 12′ chilled and solidified on the roll 28 is stripped off from the roll 28 and sent to the machine direction stretching process section 16 and the cross-machine direction stretching process section 18 sequentially to be stretched, and then to the winding process section 20 to be wound up to a reel. Thus the production of a stretched cellulose acylate film 12′ is complete. Details of the respective process sections will be described below.

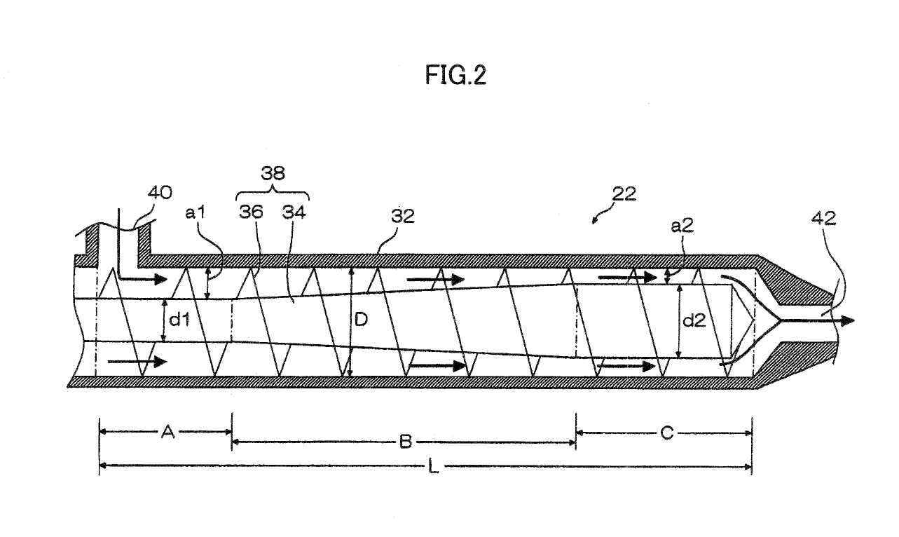

In FIG. 2 is shown a single screw extruder 22 in the film formation process section 14. As shown in FIG. 2, in a cylinder 32 a single screw 38 having a screw shaft 34 with a flight 36 is installed, and a cellulose acylate resin is fed from a hopper (not illustrated) through a feeding port 40 into the cylinder 32. In the cylinder 32 are arranged a feed zone (zone denoted as A), where the cellulose acylate resin fed from the feeding port 40 is transported constantly, a compression zone (zone denoted as B), where the cellulose acylate resin is kneaded and compressed and a metering zone (zone denoted as C), where the kneaded and compressed cellulose acylate resin is metered, from the feeding port 40 side in the mentioned order. The cellulose acylate resin molten in the extruder 22 is sent continuously through a discharge port 42 to the die 24.

The screw compression ratio of the extruder 22 is set at 2.5 to 4.5, and the L/D is set at 20 to 50. Thereby the screw compression ratio represents a volume ratio of the feed zone A to the metering zone C, namely represents the quotient of (a volume of the feed zone A per unit length) by (a volume of the metering zone C per unit length) and is calculated using the outer diameter d1 of the screw shaft 34 in the feed zone A, the outer diameter d2 of the screw shaft 34 in the metering zone C, the channel depth a1 in the feed zone A, and the channel depth a2 in the metering zone C. Further, L/D represents the ratio of the cylinder inner diameter (D) to the cylinder length (L) in FIG. 2. The extruding temperature is set at 190 to 240° C. If the temperature in the extruder 22 exceeds 240° C., it is preferable to install a cooler (not illustrated) between the extruder 22 and the die 24.

The extruder 22 may be a single screw extruder as well as a twin screw extruder, however, if the screw compression ratio is so small as below 2.5, kneading becomes insufficient which may lead to generation of unmolten solids, to insufficient generation of the shearing heat to cause insufficient melting of crystals, leaving minute crystallites in the produced cellulose acylate film, and further to vulnerability to bubble mixing. In such event, when a cellulose acylate film 12′ is stretched, the remaining crystallites would deteriorate stretchability leading to poor orientation. On the contrary, if the screw compression ratio is so large as above 4.5, heat generation by too high shearing force could lead to possible deterioration of the resin and yellowish discoloration of the produced cellulose acylate film. Further too high sharing stress could cause molecular scission lowering the molecular weight and the mechanical strength of the film. Consequently to prevent yellowish discoloration of the produced cellulose acylate film and breakage during stretching, the screw compression ratio is preferably in a range of 2.5 to 4.5, more preferably in a range of 2.8 to 4.2, and further preferably in a range of 3.0 to 4.0.

If L/D is so small as below 20, insufficient melting or insufficient kneading can take place, and as in the case of too small compression ratio, minute crystallites tend to remain in a produced cellulose acylate film. Reversely, if L/ID is so large as beyond 50, the residence time of the cellulose acylate resin in the extruder 22 becomes too long, and the resin becomes vulnerable to deterioration. The longer residence time leads to molecular scission to lower the molecular weight and mechanical strength of the film. Consequently to prevent yellowish discoloration of the produced cellulose acylate film and breakage during stretching, the L/D is preferably in a range of 20 to 50, more preferably in a range of 22 to 45, and further preferably in a range of 24 to 40.

If the extruding temperature is so low as below 190° C., insufficient melting of crystals may be caused, which apt to remain in the produced cellulose acylate film as minute crystallites, which deteriorate stretchability leading to poor orientation, when the cellulose acylate film is stretched. Reversely, if the extruding temperature is so high as beyond 240° C., the cellulose acylate resin may be deteriorated and the yellowing property (YI value) becomes poorer. Consequently to prevent yellowish discoloration of the produced cellulose acylate film and breakage during stretching, the extrusion temperature is preferably 190° C. to 240° C., more preferably in a range of 195° C. to 235° C., and further preferably in a range of 200° C. to 230° C.

By the extruder 22 structured as above is a cellulose acylate resin molten, the molten resin is continuously fed to the die 24 and extruded in a sheet form through the lips (lower edge) of the die 24. The zero shear viscosity of the cellulose acylate resin at extrusion is preferably 2,000 Pa·s or below. If the zero shear viscosity exceeds 2,000 Pa·s, the molten resin extruded through the die may outspread immediately after the extrusion sticking to the lips of the die, which may grow to a deposit causing a streaking trouble. The extruded resin sheet 12 is fed between a pair of rolls 26, 28 (see FIG. 1).

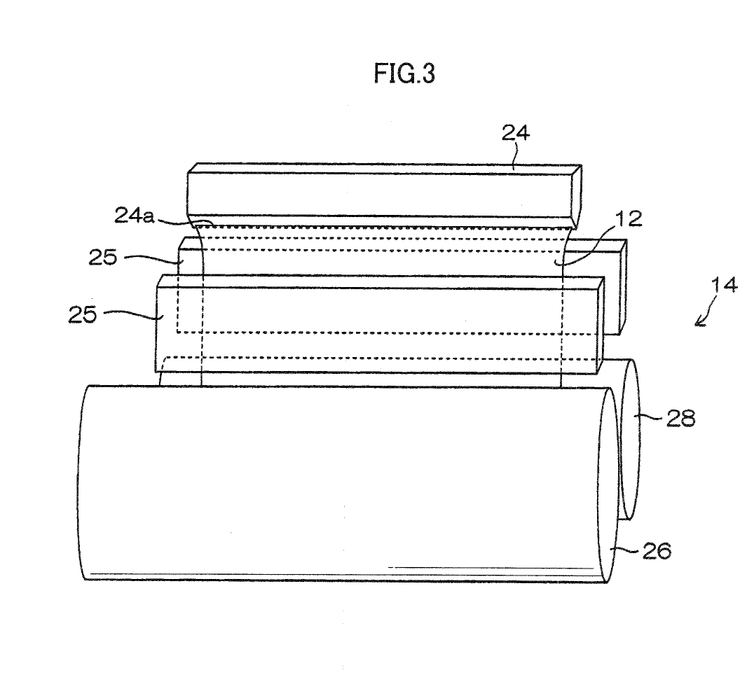

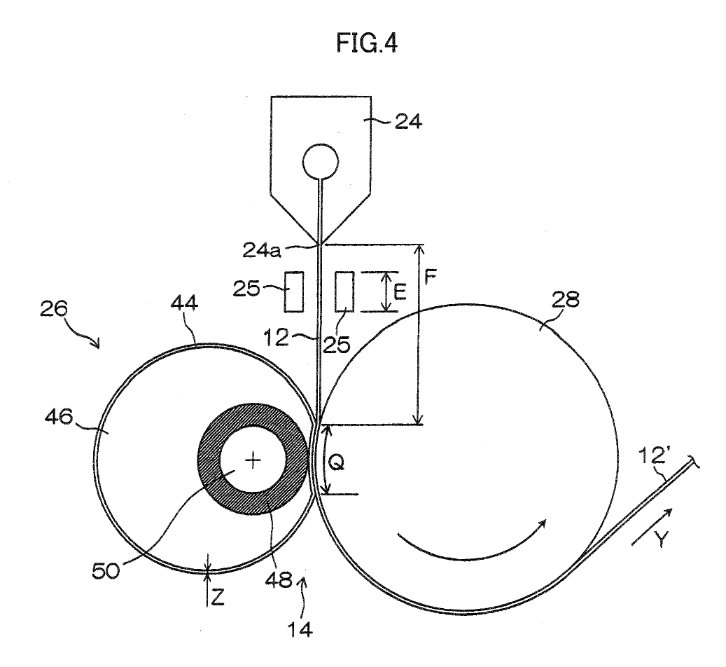

FIG. 3 and FIG. 4 show an embodiment of the present invention. The roll 26, one of the paired of rolls 26, 28, is a metallic elastic roll and the other roll is a chill roll 28. The surfaces of the respective rolls 26, 28 are mirror-finished or close to mirror-finished, so that the arithmetic average roughness (Ra) is 100 nm or below, preferably 50 nm or below, and more preferably 25 nm or below. Further, the rolls 26, 28 are so constructed that the surface temperature can be regulated. For example, a liquid medium, such as water, is circulated inside the rolls 26, 28 to regulate the surface temperature. The roll 26 of the paired rolls 26, 28 is smaller in the diameter than the other roll 28 and the surface of the roll 26 is metallic so that the surface temperature can be well regulated. The paired rolls 26, 28 rotate at the same surface speed.

Since the melt viscosity of a cellulosic resin is high, the resin sheet 12 cannot easily level out, so that a cellulosic resin film 12′ formed according to a melt-casting film formation process tends to create thickness unevenness. Consequently, the cellulose acylate film 12′ is formed by keeping the temperature difference in the cross-machine direction of the resin sheet 12 from departing the die 24 to touching the chill roll 28 within 10° C. In fact, by film-forming keeping the temperature difference in the cross-machine direction (TD) of the resin sheet 12 from departing the die 24 to touching the chill roll 28 within 10° C., development of the thickness unevenness can be suppressed. The temperature difference in the cross-machine direction is preferably within 10° C., more preferably within 5° C., and further preferably within 1° C.

Further, it is preferable to form a cellulose acylate film 12′ by keeping the temperature decrease in the machine direction (MD) of the resin sheet 12 from departing the die 24 to touching the chill roll 28 within 20° C. By film-forming keeping the temperature decrease in the machine direction of the resin sheet 12 from departing the die 24 to touching the chill roll 28 within 20° C., development of the thickness unevenness can be further suppressed. Thereby limiting the temperature decrease in the machine direction within 20° C. is especially effective against the thickness unevenness in the machine direction of the film among various directions. The temperature decrease in the machine direction is preferably within 20° C., more preferably within 10° C., and further preferably within 5° C.

To form a film keeping the temperature of the resin sheet 12 within a desired range, the sheet resin 12 is heated by the heating units 25, 25 from departing the die 24 to touching the chill roll 28 as shown in FIG. 3 and FIG. 4. The width of the heating unit should be more than 1.0-fold the width of the lips 24a of the die 24, and preferably more than 0.2-fold, and the upper limit should be preferably the roll length of the chill roll 28. Denoting the distance of the heating unit 25 in the machine direction of the resin sheet 12 (the distance between the uppermost edge and the lowermost edge of the heating unit 25) as E, and the length of the resin sheet 12 in the machine direction as F, the E/F should be 20% or more. By constructing as above, the temperature difference of the molten resin in the cross-machine direction can be limited within 110° C., and further the temperature decrease of the molten resin in the machine direction can be limited within 20° C.

The length F of the resin sheet 12 in the machine direction is preferably within 200 mm. By limiting the length of the molten resin in the machine direction within 200 mm, the temperature regulation in the cross-machine direction and a machine direction becomes easier, and development of the thickness unevenness of the cellulose acylate film 12′ can be suppressed. Thereby is the length F of the resin sheet 12 in the machine direction preferably within 200 mm, more preferably within 150 mm, and further preferably within 100 mm.

FIG. 4 shows an embodiment of a pair of rolls 26, 28. The elastic roll 26 comprises, from the outer layer in an order of, a metallic sheath (an external cylinder) 44 forming the outermost layer, a liquid medium layer 46, an elastic layer (an internal cylinder) 48 and a metallic shaft 50. The external cylinder 44 and the internal cylinder 48 of the elastic roll 26 are rotated by the rotation of the chill roll 28 contacted by the intermediary of the molten resin sheet. Thereby by nipping the molten resin sheet between the pair of rolls 26, 28, the elastic roll 26 receives reaction force from the chill roll 28 by the intermediary of the sheet and becomes deformed elastically into a concave form along the surface of the chill roll 28. Consequently, the elastic roll 26 and the chill roll 28 can have plane contact with the sheet, and the nipped sheet can be chilled by the chill roll 28 while being pressed in a plane form by a restoring force of the elastically deformed elastic roll 26 generated in returning to the original form. A metallic sheath 44 is manufactured of a metal film, and preferably has a seamless structure without a welded joint. The film thickness Z of the metallic sheath 44 is preferably in a range of 0.05 mm to 7.0 mm. In case the film thickness Z is 0.05 mm or less, not only the restoring force is so low that a sufficient surface quality improving effect cannot be obtained, but also the strength of the roll is compromised. In case the film thickness Z is 7.0 mm or more, the elasticity is so low that a releasing effect of a residual strain cannot be obtained. Although the film thickness Z of the metallic sheath 44 satisfying the condition of 0.05 mm≦z≦7.0 mm is acceptable, more preferably to satisfy 0.2 mm≦z≦5.0 mm.

Putting the difference of the glass transition temperature Tg (° C.) of a cellulose acylate resin minus the temperature (° C.) of the elastic roll 26 as X (° C.) and the film forming speed as Y (m/min), the film forming speed Y and the temperature of the elastic roll 26 should be preferably regulated to satisfy the relationship of: 0.0043X²+0.12X+1.1<y<0.019X²+0.73X+24. If the film forming speed Y is lower than 0.0043X²+0.12X+1.1, the pressurized time is so long that the residual strain remains in a film, and if the film forming speed Y is higher than 0.019X²+0.73X+24, the chilling time is so short that the film is not cooled down gradually and sticks to the elastic roll 26. In this context the temperature of the chill roll 28 is preferably within ±20° C. of the temperature of the elastic roll 26, more preferably within ±15° C., and further preferably within ±10° C.

Further, putting the contact length of the elastic roll 26 and the chill roll 28 of the paired rolls 26, 28 with the intermediary of the sheet of a cellulose acylate resin as Q (cm), and the line pressure, under which the sheet of the cellulose acylate resin is nipped between the elastic roll 26 and the chill roll 28 as P (kg/cm), the line pressure P and the contact length Q should be preferably determined to satisfy the relationship of: 3 kg/cm²<P/Q<50 kg/cm². If P/Q is less than 3 kg/cm², the pressurizing force on the resin deforming to a flat plane is so low that a planar property improving effect cannot be obtained. If P/Q is more than 50 kg/cm², the pressurizing force is so high that a residual strain remains in the film to generate retardation.

In the film formation process section 14 constructed as above, a cellulose acylate resin is extruded through the die 24, the extruded cellulose acylate resin builds a tiny pool of the melt between the paired rolls 26, 28, and the cellulose acylate resin is formed to a sheet while the thickness thereof being regulated by nipping between the paired rolls 26, 28. Thereby, the elastic roll 26 receives the reaction force from the chill roll 28 by the intermediary of the cellulose acylate resin and becomes deformed elastically into a concave form along the surface of the chill roll 28, and the cellulose acylate resin is pressurized planarly by the elastic roll 26 and the chill roll 28. In case the film 12′ is formed by nipping the same with the rolls 26, 28 having the film thickness Z of the external cylinder, the temperature, the line pressure and the chilling length satisfying the above-described relationships, a cellulose acylate film 12′ with least streaking trouble, high thickness accuracy and inhibited residual strain generating little retardation suitable for an optical film can be produced. In the film formation process section 14 constructed as above, a cellulose acylate film 12′ with the film thickness of 20 to 300 μm, the in-plane retardation Re of 20 mm or less and the thickness-direction retardation Rth of 20 m or less can be produced.

The retardations Re, Rth can be calculated by the following formulas.

Re(nm)=|n(MD)−n(TD)|×T(nm)

Rth(nm)=|{(n(MD)+n(TD))/2}−n(TH)|×T(nm)

where n(MD), n(TD), and n(TH) represent the refractive indices in the longitudinal (machine) direction, cross-machine direction and thickness direction respectively, and T (nm) represents the thickness expressed in the unit of nm.

A film 12′ nipped by the rolls 26, 28 is wound on the metallic roll 28 to be chilled, and then stripped off from the surface of the roll 28, and sent to the subsequent machine direction stretching process section 16.

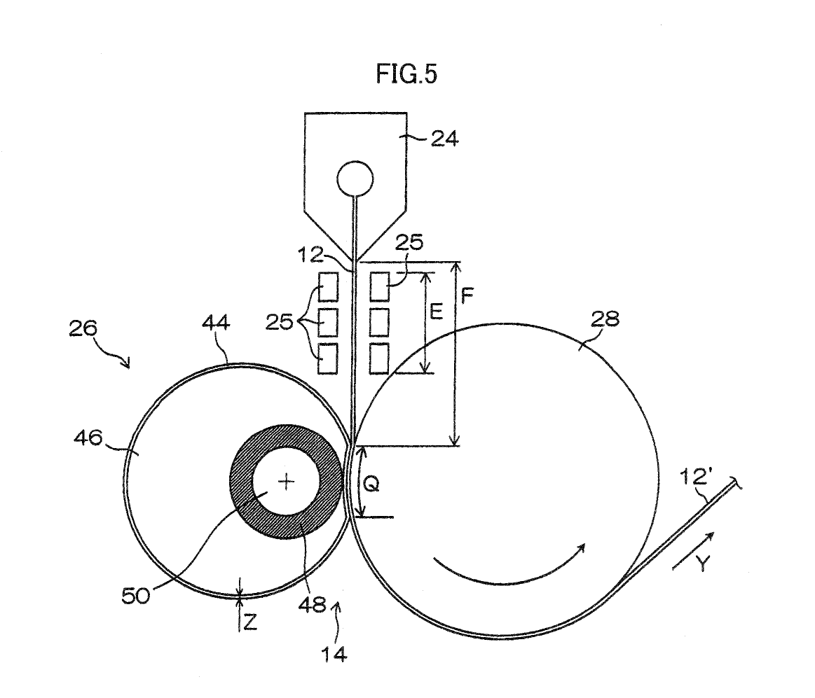

Although an embodiment of the cellulosic resin film of the present invention and the process for producing the same has been described hereinabove, the present invention is not limited thereto, and various other embodiments thereof are possible. FIG. 5 shows another embodiment of the present invention, in which a plurality of heating units 25 are arranged in the machine direction of the molten resin. With such arrangement, denoting the distance of the heating units 25, 25, . . . in the machine direction of the resin sheet 12 (the distance between the uppermost end and the lowermost end of the heating units 25) as E and the length of the resin sheet 12 in the machine direction as F, the E/F can be easily set at 20% or higher. The E/F is preferably 20% or higher, more preferably 50% or higher, and further preferably 70% or higher.

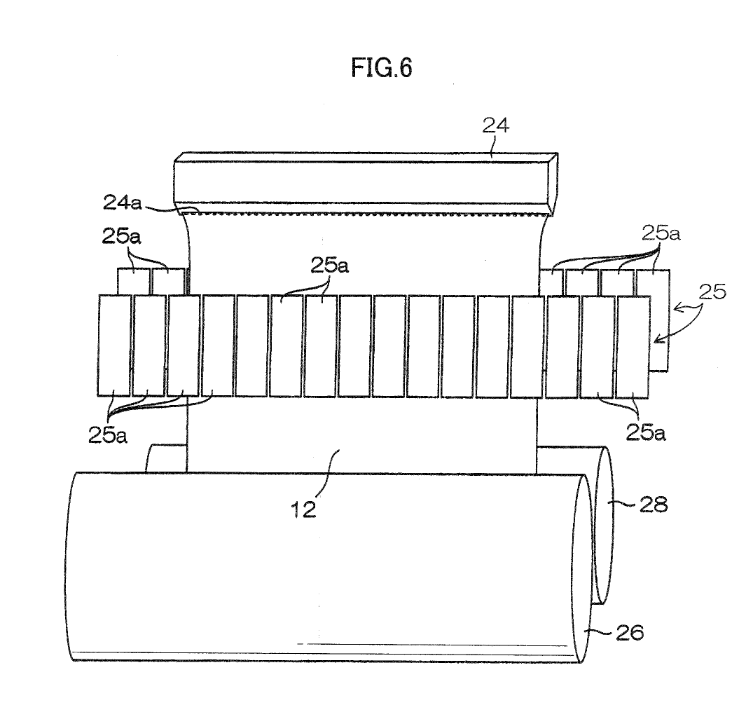

In case a heating unit 25 is constructed by arranging heaters 25a, 25a, . . . in the cross-machine direction as shown in FIG. 6, heating temperatures can be regulated in the cross-machine direction of the resin sheet 12. By regulating the heating temperatures of the heating unit 25 in the cross-machine direction of the resin sheet 12, the thickness unevenness in the cross-machine direction can be further suppressed.

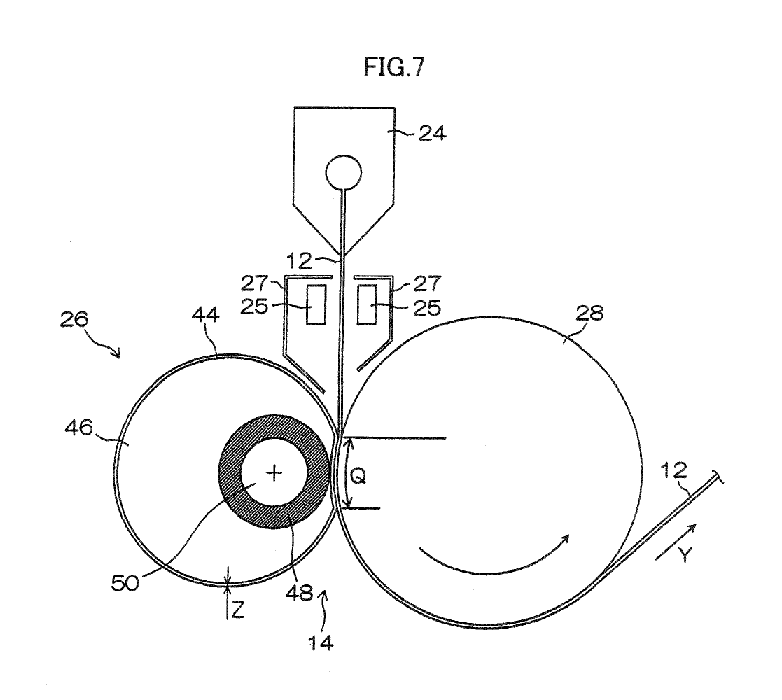

Further, it is conceivable to sheathe the resin sheet 12 and the heating unit 25 by a cover 27 having a heat-insulation function and/or a heat-reflection function, as shown in FIG. 7. By sheathing the resin sheet 12 from departing the die 24 to touching the chill roll 26 and the heating unit 25 by the cover 27 having a heat-insulation function and/or a heat-reflection function, the temperature difference in the cross-machine direction of the resin sheet can be efficiently suppressed, and development of the thickness unevenness of the film can be suppressed.

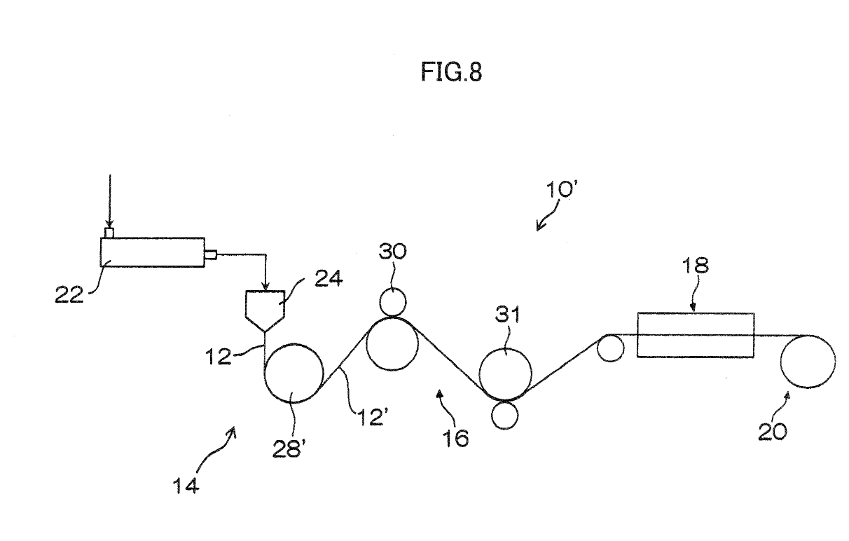

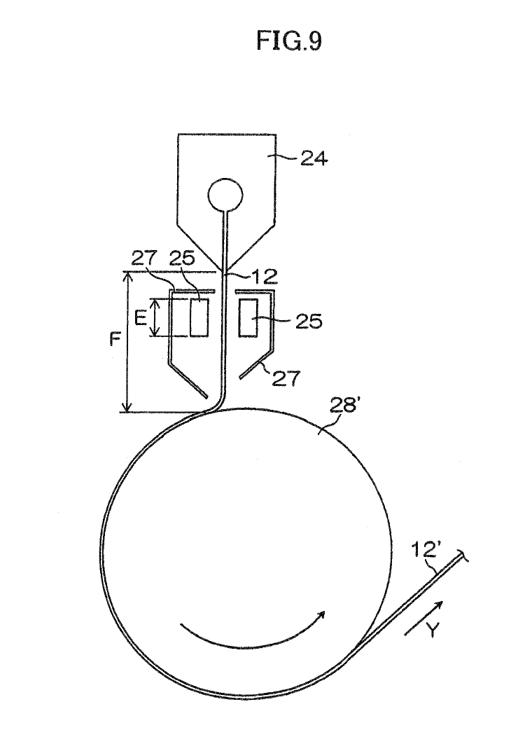

The present invention is not limited to film formation by the touch-roll process, in which the resin extruded from the die is nipped and chilled by the paired rolls (see FIG. 1), but also applicable to film formation by the casting-drum process as shown in FIG. 8 and FIG. 9, in which the resin extruded from the die is chilled on a casting roll 28′.

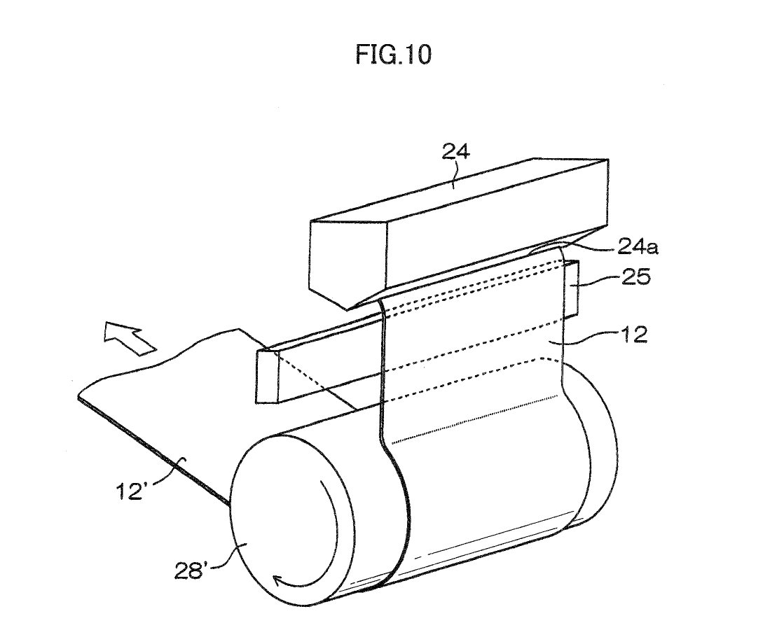

Further, according to the present invention as shown in FIG. 10, the heating unit 25 may be placed only at one side of the resin sheet 12 to heat at least one surface, still being able to limit the temperature difference of the resin sheet 12 in the cross-machine direction within 10° C., and thus to suppress the thickness unevenness of the film 12′.

The stretching process section, in which the cellulose acylate film 12′ produced in the film formation process section 14 is stretched to produce a stretched cellulose acylate film 12′, will be explained below.

The cellulose acylate film 12′ is stretched in order to orient molecules in the cellulose acylate film 12′ for generating the in-plane retardation (Re) and the thickness-direction retardation (Rth).

As shown in FIG. 1 or FIG. 8, the cellulose acylate film 12′ is stretched first in the longitudinal direction in the machine direction stretching process section 16. In the machine direction stretching process section 16 is the cellulose acylate film 12′ pre-heated and the cellulose acylate film 12′ as heated is wound on 2 pairs of nip rolls 30, 31. The outlet nip rolls 31 transport the cellulose acylate film 12′ at a faster transportation speed than the inlet nip rolls 30, which stretches the cellulose acylate film 12′ in the machine direction.

In the machine direction stretching process section 16 is the pre-heating temperature preferably between Tg−40° C. and Tg+60° C., more preferably between Tg−20° C. and Tg+40° C., and further preferably between Tg and Tg+30° C. And the stretching temperature in the machine direction stretching process section 16 is preferably between Tg and Tg+60° C., more preferably between Tg+2° C. and Tg+40° C., and further preferably between Tg+5° C. and Tg+30° C. The machine-direction stretching ratio is preferably between 1.0 and 2.5, and more preferably between 1.1 and 2.

The cellulose acylate film 12′ stretched in the machine direction is sent to the cross-machine direction stretching process section 18 and stretched in the cross-machine direction. In the cross-machine direction stretching process section 18, a tenter can be favorably used, for example, which grips both the cross-machine direction sides of the cellulose acylate film 12′ using clips and stretches the same in the cross-section direction. By this cross-machine direction stretching, the retardation Rth can be further increased.

The cross-machine direction stretching is preferably carried out by a tenter, and the stretching temperature is preferably between Tg and Tg+60° C., more preferably between Tg+2° C. and Tg+40° C., and further preferably between Tg+4° C. and Tg+30° C. The stretching ratio is preferably between 1.0 and 2.5, and more preferably between 1.1 and 2.0. After the cross-machine direction stretching, the film is preferably relaxed either in the machine direction or in the cross-machine direction, or in both the directions. This can decrease the fluctuation of the slow axes in the cross-machine direction.

As a result of the stretching, Re is preferably between 0 nm and 500 nm, more preferably between 10 nm and 400 nm, and further preferably between 15 nm and 300 nm, and Rth is preferably between 0 nm and 500 nm, more preferably between 50 nm and 400 nm, and further preferably between 70 nm and 350 nm.

Among them, the film should more preferably satisfy Re<Rth, and further preferably satisfy Re×2≦Rth. To actualize such high Rth and low Re, it is preferable to stretch the machine-direction stretched film further in the cross-machine direction. Namely, the difference in orientation to the machine direction and the cross-machine direction causes the in-plane difference in retardation (Re), which (in-plane orientation) can be decreased by decreasing the difference in orientation in the machine direction and the cross-machine direction by stretching the film in the machine direction as well as in the direction orthogonal thereto, namely in the cross-machine direction. On the other hand, the stretching in both the direction increases the film area and decreases the thickness, which increases orientation in the thickness direction making Rth increase.

Further, it is preferable to limit the fluctuation of Re and Rth by location in the machine direction and in the cross-machine direction within 5%, more preferable within 4%, and further preferable within 3%.

As described above, according to the present embodiment, the cellulose acylate film 12′ with the suppressed thickness unevenness can be produced in the film formation process section 14, and therefore by stretching the cellulose acylate film 12′ in the machine direction and in the cross-machine direction the cellulose acylate film 12′ without fluctuation in stretching can be produced.

The stretched cellulose acylate film 12′ is wound up to a reel in the winding process section 20 shown in FIG. 1. Thereby it is preferable to limit the winding tension for the cellulose acylate film 12′ to 0.02 kg/mm² or below. By limiting the winding tension in such range, the stretched cellulose acylate film 12′ can be wound up without generating the retardation fluctuation.

Details of the cellulose acylate resins suitable for the present invention and processing methods of the cellulose acylate film will be explained stepwise.

(1) Plasticizer

It is preferable to add a polyhydric alcohol-type plasticizer to a source resin for producing a cellulose acylate film according to the present invention. Such a plasticized works not only to decrease the elastic modulus, but also to mitigate the difference in crystallinities at the top and bottom side of the film. The content of the polyhydric alcohol-type plasticizer is preferably 2 to 20 weight-% with respect to the cellulose acylate, more preferably 3 to 18 weight-%, and further preferably 4 to 15 weight-%.

In case the content of the polyhydric alcohol-type plasticizer is less than 2 weight-%, the above-mentioned activity cannot be obtained sufficiently, and in case it is more than 20 weight-% bleeding (separation of a plasticizer at the surface) occurs. Specific examples of a plasticizer to be used for the present invention, having good compatibility with cellulose fatty acid ester and expressing good plasticizing activity, include: an ester compound with glycerin, such as a glycerin ester and a diglycerin ester, a polyalkylene glycol, such as polyethylene glycol and polypropylene glycol, and a compound of polyalkylene glycol whose hydroxy group is bonded with an acyl group.

Specific examples of a glycerin ester include, but not limited to, glycerin diacetate stearate, glycerin diacetate palmitate, glycerin diacetate mystirate, glycerin diacetate laurate, glycerin diacetate caproate, glycerin diacetate nonanoate, glycerin diacetate octanoate, glycerin diacetate heptanoate, glycerin diacetate hexanoate, glycerin diacetate pentanoate, glycerin diacetate oleate, glycerin acetate dicaproate, glycerin acetate dinonanoate, glycerin acetate dioctanoate, glycerin acetate diheptanoate, glycerin acetate dicaproate, glycerin acetate divalerate, glycerin acetate dibutyrate, glycerin dipropionate caproate, glycerin dipropionate laurate, glycerin dipropionate mystirate, glycerin dipropionate palmitate, glycerin dipropionate stearate, glycerin dipropionate oleate, glycerin tributyrate, glycerin tnIpentanoate, glycerin monopalmitate, glycerin monostearate, glycerine distearate, glycerin propionate laurate and glycerin oleate propionate. The above may be used singly or in combination.

Among these are preferable glycerin diacetate caprylate, glycerin diacetate pelargonate, glycerin diacetate caproate, glycerin diacetate laurate, glycerin diacetate myristate, glycerin diacetate palmitate, glycerin diacetate stearate and glycerin diacetate oleate.

Specific examples of a diglycerin ester include, but not limited to, mixed acid esters of diglycerin, such as diglycerin tetraacetate, diglycerin tetrapropionate, diglycerin tetrabutyrate, diglycerin tetravalerate, diglycerin tetrahexanoate, diglycerin tetraheptanoate, diglycerin tetracaprylate, diglycerin tetrapelargonate, diglycerin tetracaproate, diglycerin tetralaurate, diglycerin tetra mystirate, diglycerin tetrapalmitate, diglycerin triacetate propionate, diglycerin triacetate butyrate, diglycerin triacetate valerate, diglycerin triacetate hexanoate, diglycerin triacetate heptanoate, diglycerin triacetate caprylate, diglycerin triacetate pelargonate, diglycerin triacetate caproate, diglycerin triacetate laurate, diglycerin triacetate mystirate, diglycerin triacetate palmitate, diglycerin triacetate stearate, diglycerin triacetate oleate, diglycerin diacetate dipropionate, diglycerin diacetate dibutyrate, diglycerin diacetate divalerate, diglycerin diacetate dihexanoate, diglycerin diacetate diheptanoate, diglycerin diacetate dicaprylate, diglycerin diacetate dipelargonate, diglycerin diacetate dicaproate, diglycerin diacetate dilaurate, diglycerin diacetate dimystirate, diglycerin diacetate dipalmitate, diglycerin diacetate distearate, diglycerin diacetate dioleate, diglycerin acetate tripropionate, diglycerin acetate tributyrate, diglycerin acetate trivalerate, diglycerin acetate trihexanoate, diglycerin acetate triheptanoate, diglycerin acetate tricaprylate, diglycerin acetate tripelargonate, diglycerin acetate tricaproate, diglycerin acetate trilaurate, diglycerin acetate trimystirate, diglycerin acetate tripalmitate, diglycerin acetate tristearate, diglycerin acetate trioleate, diglycerin laurate, diglycerin stearate, diglycerin caprylate, diglycerin myristate and diglycerin oleate. The above may be used singly or in combination.

Among these are preferable diglycerin tetraacetate, diglycerin tetrapropionate, diglycerin tetrabutyrate, diglycerin tetracaprylate and diglycerin tetralaurate.

Specific examples of polyalkylene glycol include, but not limited to, polyethylene glycol and polypropylene glycol having an average molecular weight of 200 to 1,000, which may be used singly or in combination.

Specific examples of a compound of polyalkylene glycol whose hydroxy group is bonded with an acyl group include, but not limited to, polyoxyethylene acetate, polyoxyethylene propionate, polyoxyethylene butyrate, polyoxyethylene valerate, polyoxyethylene caproate, polyoxyethylene heptanoate, polyoxyethylene octanoate, polyoxyethylene nonanoate, polyoxyethylene caproate, polyoxyethylene laurate, polyoxyethylene myristate, polyoxyethylene palmitate, polyoxyethylene stearate, polyoxyethylene oleate, polyoxyethylene linoleate, polyoxypropylene acetate, polyoxypropylene propionate, polyoxypropylene butyrate, polyoxypropylene valerate, polyoxypropylene caproate, polyoxypropylene heptanoate, polyoxypropylene octanoate, polyoxypropylene nonanoate, polyoxypropylene caproate, polyoxypropylene laurate, polyoxypropylene myristate, polyoxypropylene palmitate, polyoxypropylene stearate, polyoxypropylene oleate and polyoxypropylene linoleate. The above may be used singly or in combination.

Furthermore in order to fully express the activity of these polyhydric alcohols, it is preferable to form a cellulose acylate into a film by melt-casting film formation under the following conditions. Namely, when pellets of a mixture of a cellulose acylate and a polyhydric alcohol are molten in an extruder and extruded through the T-die to form a film, it is preferable to keep the extruder temperature at the outlet (T2) higher than the extruder temperature at the inlet (T1), and further preferably to keep the die temperature (T3) higher than T2. In other words, the temperature should preferably rise in parallel with advancement of melting. If the temperature is elevated too rapidly at the inlet, the polyhydric alcohol first melts to a liquid. The cellulose acylate floats in the liquid and unable to receive sufficiently the shearing force of the screw, leaving non-molten parts. In such a heterogeneous blend the plasticizer cannot express the activity as described above, and the effect of suppressing the difference between the top and bottom surface of the extruded molten film cannot be obtained. Further, the insufficiently molten materials appear as foreign matters like fisheyes after film formation. Such foreign matters are not to be identified as bright points under observation with a polarizer, rather recognizable visually on the screen when light is projected from the backside of the film. Further, the fisheye causes tailing at the die outlet and increases also die lines.

The T1 is preferably 150 to 200° C., more preferably 160 to 195° C., and further preferably 165° C. to 190° C. The T2 is preferably in a range of 190 to 240° C., more preferably 200 to 230° C., and further preferably 200 to 225° C. It is crucial that the melt temperatures of T1 and T2 should not exceed 240° C. Beyond that temperature, the elastic modulus of the formed film tends to rise. This rise of the elastic modulus is probably attributable to cross-linking caused by degradation of cellulose acylate due to melting at a high temperature. The die temperature T3 is preferably 200 to 235° C., more preferably 205 to 230° C., and further preferably 205° C. to 225° C.

(2) Stabilizer

For the present invention, either or both of a phosphite type compound and a phosphorous acid ester type compound are preferably used as a stabilizer. They inhibits aging, and additionally improves die lines, because the compound works as a leveling agent, which diminishes die lines caused by unevenness of the die. The blended content of the stabilizer is preferably 0.005 to 0.5 weight-%, more preferably 0.01 to 0.4 weight-%, and further preferably 0.02 to 0.3 weight-%.

(i) Phosphite Type Stabilizer

Although there is no restriction on a specific phosphite type color stabilizer, such phosphite type color stabilizers as represented by the chemical formulas (1) to (3) are preferable.

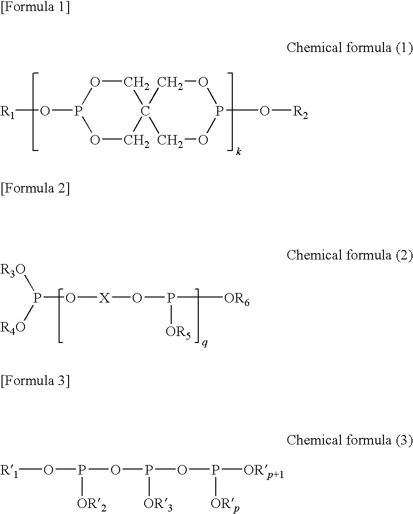

wherein R1, R2, R3, R4, R5, R6, R′1, R′2, R′3 . . . R′n and R′n+1 represent a hydrogen atom or a group selected from the set consisting of alkyl, aryl, alkoxyalkyl, aryloxyalkyl, alkoxyaryl, arylalkyl, alkylaryl, polyaryloxyalkyl, polyalkoxyalkyl and polyalkoxyaryl groups having 4 to 23 carbon atoms, provided that not all of them existing in any one of the chemical formulas (2), (3) and (4) are simultaneously hydrogen atoms. The X in a phosphite type color stabilizer represented by the chemical formula (3) represents a group selected from the set consisting of an aliphatic chain, an aliphatic chain having an aromatic nucleus as a side chain, an aliphatic chain having an aromatic nucleus in the chain, and a chain having two or more oxygen atoms existing not consecutively in any of the above-listed chains. The k and q represent an integer of 1 or higher, and the p represents an integer of 3 or higher.

The number of k and q of the phosphite type color stabilizer are preferably 1 to 10. In case k and q are 1 or higher, the volatility at heating becomes low. In case they are 10 or lower, the compatibility with cellulose acetate propionate is favorably increased. The value of p is preferable 3 to 10. In case p is 3 or higher the volatility at heating becomes low. In case p is 10 or lower, the compatibility with cellulose acetate propionate is favorably increased.

Specific and preferable examples of the phosphite type color stabilizer represented by the following chemical formula (2) include those represented by the chemical formulas (5) to (8).

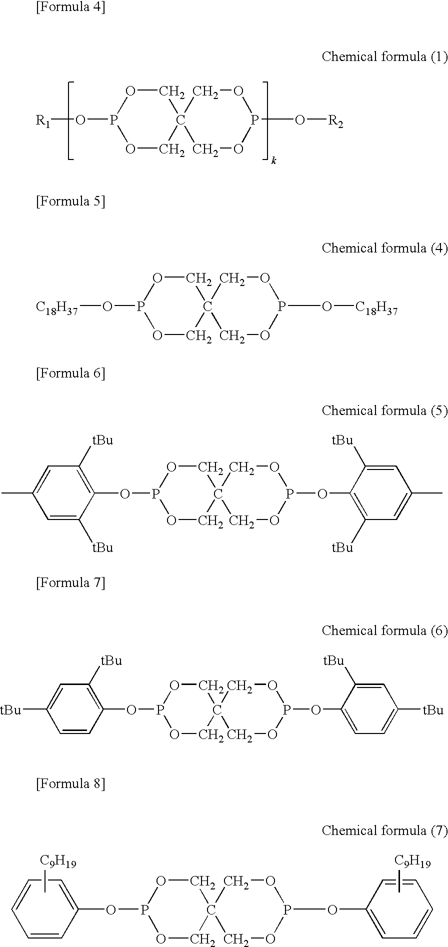

Specific and preferable examples of the phosphite type color stabilizer represented by the following chemical formula (2) include those represented by the following chemical formulas (8), (9) and (10)

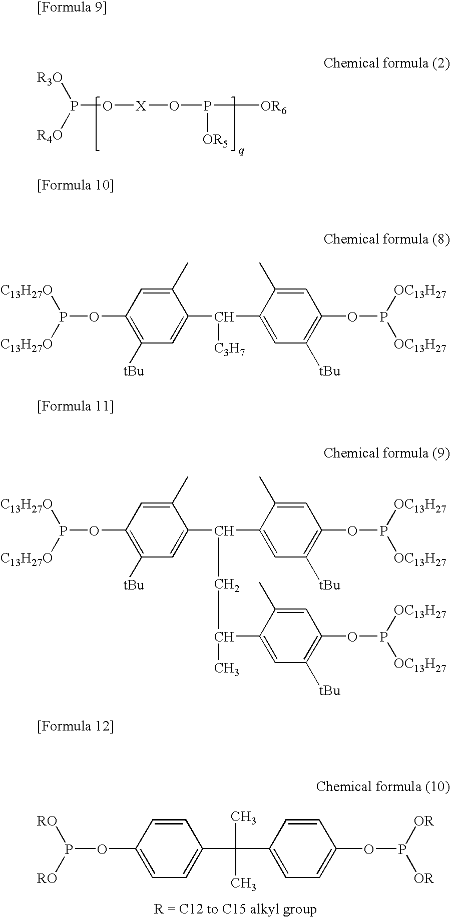

(ii) Phosphorous Acid Ester Type Stabilizer

Examples of a phosphorous acid ester type stabilizer include cyclic neopentanetetraylbis(octadecyl)phosphite, cyclic neopentanetetraylbis(2,4-di-t-butylphenyl)phosphite, cyclic neopentanetetraylbis(2,6-di-t-butyl-4-methylphenyl)phosphite, 2,2-methylenebis(4,6-di-t-butylphenyl)octylphosphite, and tris(2,4-di-butylphenyl)phosphite.

(iii) Other Stabilizers

A weak organic acid, a thioether compound or an epoxy compound may be blended as a stabilizer.

A week organic acid is a compound having pKa of 1 or higher. There is no restriction on selection insofar as it does not interfere with the activity according to the present invention and has anti-discoloration activity and anti-aging activity. Examples include tartaric acid, citric acid, malic acid, fumaric acid, oxalic acid, succinic acid, and maleic acid. They may be used singly or in combination of two or more.

Examples of a thioether compound include dilaurylthiodipropionate, ditridecylthiodipropionate, dimyristylthiodipropionate, distearylthiodipropionate and palmitylstearylthiodipropionate. They may be used singly or in combination of two or more.

Examples of an epoxy compound include a derived of epichlorohydrin and bisphenol A, a derivative of epichlorohydrin and glycerin and a cyclic compound, such as vinylcyclohexene dioxide and 3,4-epoxy-6-methylcyclohexylmethyl-3,4-epoxy-6-methylcyclohexane carboxylate. Furthermore, an epoxidized soybean oil, an epoxidized castor oil, and long chain-α-olefin oxides may be used. They may be used singly or in combination of two or more.

(3) Cellulose Acylate

[Cellulose Acylate Resin]

(Composition/Substitution Degree)

A cellulose acylate satisfying all the requirements represented by the following formulas (1) to (3) is preferable as the cellulose acylate to be used in the present invention.

2.0≦A+B≦3.0 Formula (1)

0≦A≦2.0 Formula (2)

1.0≦B≦2.9 Formula (3)

In the formulas (1) to (3), A represents a substitution degree of an acetate group, B represents the sum of the substitution degrees of a propionate group, a butyrate group, a pentanoyl group and a hexanoyl group.

### Preferably,

2.0≦A+B≦3.0 Formula (4)

0≦A≦2.0 Formula (5)

1.2≦B≦2.9 Formula (6)

more preferably,

2.4≦A+B≦3.0 Formula (7)

0.05≦A≦1.7 Formula (8)

1.3≦B≦2.9 Formula (9)

further preferably,

2.5≦A+B≦2.95 Formula (10)

0.1≦A≦1.55 Formula (11)

1.4≦B≦2.85 Formula (12)

The cellulose acylate is produced characteristically by introducing a propionate group, a butyrate group, a pentanoyl group and a hexanoyl group into cellulose as described above. By fulfilling the above ranges, the melting temperature can be lowered and thermolysis associated with melt-casting film formation can be favorably suppressed. Outside the above ranges, it becomes unfavorable, since the melting temperature becomes too close to the thermolysis temperature, and thermolysis can be hardly inhibited.

Such cellulose acylates may be used singly or in combination of two or more types. A polymer component other than a cellulose acylate may be blended appropriately.

Next, a method for producing the cellulose acylate to be used in the present invention will be explained in more details. A source cotton and a synthetic method for the cellulose acylate of the present invention are also described in details in Journal of Technical Disclosure (Disclosure No. 2001-1745, published on 15 Mar. 2001 by the Japan Institute of Invention and Innovation, p. 7 to 12).

(Source Materials and Pretreatment)

Favorably used source cellulose is derived from hard-wood pulp, soft-wood pulp and cotton linter. As source cellulose, a high-purity material containing α-cellulose in a range of 92 mass-% to 99.9 mass-% is preferably used.

If a source cellulose is in a sheet or bale form, it should be preferably opened up in advance, so that the opening of cellulose has preferably advanced to a fluffy state.

(Activation)

Prior to acylation, it is preferable that the source cellulose is brought into contact with an activating agent (activation treatment). As the activating agent, a carboxylic acid or water may be used. In case water is used, it is preferable to have a treatment step after the activation, such as adding excess of acid anhydride to remove water, or washing the product with a carboxylic acid to replace water, or adjusting the conditions for acylation. An activating agent may be added after adjusted to an appropriate temperature. A method of addition thereof may be selected from spraying, dropping and dipping.

Preferable examples of a carboxylic acid for an activating agent include a carboxylic acid having 2 to 7 carbon atoms, such as acetic acid, propionic acid, butyric acid, 2-methylpropionic acid, valeric acid, 3-methylbutyric acid, 2-methylbutyric acid, 2,2-dimethylpropionic acid (pivalic acid), hexanoic acid, 2-methylvaleric acid, 3-methylvaleric acid, 4-methylvaleric acid, 2,2-dimethylbutyric acid, 2,3-dimethylbutyric acid, 3,3-dimethylbutyric acid, cyclopentane carboxylic acid, heptanoic acid, cyclohexane carboxylic acid, and benzoic acid; more preferable examples are acetic acid, propionic acid and butyric acid; and a further preferable example is acetic acid.

By activation, if necessary, an acylation catalyst such as sulfuric acid may be further added. However, the amount to be added should preferably be limited to a range of 0.1 mass-% to 10 mass-%, because an added strong acid such as sulfuric acid may accelerate depolymerization. Two or more activating agents may be used in combination, and an anhydride of a carboxylic acid having 2 to 7 carbon atoms may be added.

The addition amount of an activating agent is preferably 5 mass-% or more with respect to cellulose, more preferably 10 mass-% or more, and further preferably 30 mass-% or more. If the amount of an activating agent is more than the lower limit, inconvenience such as low degree of activation of cellulose should be favorably prevented. Although there is no upper limit of the addition amount of an activating agent, insofar as the productivity is not reduced; the amount is preferably 100-fold or less by mass of cellulose, more preferably 20-fold or less, and further preferably 10-fold or less. Alternatively, a large excess of an activating agent relative to cellulose is used for activation, and then the amount of the activating agent is decreased by a treatment, such as filtration, aerated drying, heat drying, vacuum evaporation and solvent replacement.

The activation time is preferably 20 min or longer. Although there is no upper limit of the activation time, insofar as the productivity is not reduced; the activation time is preferably 72 hours or less, more preferably 24 hours or less, and further preferably 12 hours or less. The activation temperature is preferably between 0° C. and 90° C., more preferably between 15° C. and 80° C., and further preferably between 20° C. and 60° C. The procedure of the activation of cellulose may be carried out under a high pressure or a reduced pressure. As means for heating, an electromagnetic wave, such as microwave and infrared rays, may be used.

(Acylation)

By a preferable method for producing the cellulose acylate according to the present invention, a carboxylic acid anhydride is admixed with cellulose for reaction using a Bronsted acid or a Lewis acid as a catalyst to acylate hydroxy groups of cellulose.

To obtain a cellulose mixed-acylate, may be used any of: a method of adding simultaneously or successively two types of carboxylic acid anhydrides as acylating agents for reaction with cellulose; a method of using a mixed acid anhydride of two carboxylic acids (e.g., mixed acid anhydride of acetic acid and propionic acid); a method of synthesizing a mixed acid anhydride (e.g., mixed acid anhydride of acetic acid and propionic acid) in a reaction system from a carboxylic acid and an anhydride of a different carboxylic acid (e.g., acetic acid and propionic anhydride) for reaction with cellulose; and a method of once synthesizing a cellulose acylate having the substitution degree of less than 3 followed by additional acylation of the remaining hydroxyl groups with an acid anhydride or an acid halide.

(Acid Anhydride)

A preferable carboxylic acid anhydride has 2 to 7 carbon atoms in a carboxylic acid segment, and examples thereof include: acetic anhydride, propionic anhydride, butyric anhydride, 2-methylpropionic anhydride, valeric anhydride, 3-methylbutyric anhydride, 2-methylbutyric anhydride, 2,2-dimethylpropionic anhydride (pivalic anhydride), hexanoic anhydride, 2-methylvaleric anhydride, 3-methylvaleric anhydride, 4-methylvaleric anhydride, 2,2-dimethylbutyric anhydride, 2,3-dimethylbutyric anhydride, 3,3-dimethylbutyric anhydride, cyclopentane carboxylic anhydride, heptanoic anhydride, cyclohexane carboxylic anhydride and benzoic anhydride. More preferable examples include acetic anhydride, propionic anhydride, butyric anhydride, valeric anhydride, hexanoic anhydride and heptanoic anhydride; and further preferable examples include acetic anhydride, propionic anhydride and butyric anhydride.

A mixture of the above anhydrides is favorably used for preparing a mixed ester. It is preferable to determine the mixture ratio depending on the substitution degree of the object mixed ester. The acid anhydride is usually added in an excessive equivalence with respect to cellulose. More specifically, it is preferable to add the same in an amount of 1.2 to 50 equivalents to hydroxy groups of cellulose, more preferably to add 1.5 to 30 equivalents, and further preferably to add 2 to 10 equivalents.

(Catalyst)

It is preferable to use a Bronsted acid or a Lewis acid as an acylation catalyst to be used for producing a cellulose acylate according to the present invention. The definitions of Bronsted acid and Lewis acid are set forth for example in Dictionary of Physics and Chemistry 5th Edition (2000). Examples of a preferable Bronsted acid include sulfuric acid, perchloric acid, phosphoric acid, methanesulfonic acid, benzenesulfonic acid, p-toluenesulfonic acid. Examples of a preferable Lewis acid include zinc chloride, tin chloride, antimony chloride, magnesium chloride.

As the catalyst are sulfuric acid and perchloric acid more preferable, and sulfuric acid is particularly preferable. The preferable addition amount of the catalyst is 0.1 to 30 mass-% with respect to cellulose, more preferable is 1 to 15 mass-%, and further preferable is 3 to 12 mass-%.

(Solvent)

In acylation, a solvent may be used for the purpose of controlling the viscosity, the reaction rate, the stirring capability and the acyl substitution ratio. As the solvent may be used dichloromethane, chloroform, a carboxylic acid, acetone, ethyl methyl ketone, toluene, dimethylsulfoxide and sulfolane. However, favorable is a carboxylic acid, and such carboxylic acid having 2 to 7 carbon atoms may be exemplified, as acetic acid, propionic acid, butyric acid, 2-methylpropionic acid, valeric acid, 3-methylbutyric acid, 2-methylbutyric acid, 2,2-dimethylpropionic acid (pivalic acid), hexanoic acid, 2-methylvaleric acid, 3-methylvaleric acid, 4-methylvaleric acid, 2,2-dimethylbutyric acid, 2,3-dimethylbutyric acid, 3,3-dimethylbutyric acid, cyclopentanecarboxylic acid. Examples of a more preferable solvent include acetic acid, propionic acid and butyric acid. These solvents may be mixed for use.

(Conditions for Acylation)

In acylation, an acid anhydride, a catalyst and additionally, if necessary, a solvent may be mixed first and then with cellulose; or they may be successively mixed with cellulose. In general, however, it is preferable that a mixture of an acid anhydride and a catalyst, or a mixture of an acid anhydride, a catalyst anid a solvent is prepared as an acylating agent, and this is reacted with cellulose. In order to suppress the temperature increase inside the reactor by the reaction heat of acylation, it is preferable to cool previously the acylating agent. The cooling temperature is preferably −50° C. to 20° C., more preferably −35° C. to 10° C., and further preferably −25° C. to 5° C. The acylating agent may be added as a liquid or as a frozen solid in a crystal form, a flake form or a block form.

Further, the acylating agent may be added to cellulose at one time, or divided portions may be added separately. Alternatively, cellulose may be added to the acylating agent at one time, or divided portions may be added separately. In case the addition of the acylating agent is conducted divisionally, an acylating agent with the same composition or acylating agents with a plurality of compositions may be used. Preferable examples include: 1) a mixture of an acid anhydride and a solvent is charged first, and then a catalyst is added; 2) a mixture of an acid anhydride and a part of a solvent and a catalyst is charged first, and then a mixture of the remaining catalyst and solvent is added; 3) a mixture of an acid anhydride and a solvent is charged first, and then a mixture of a catalyst and a solvent is added; and 4) a solvent is charged first, and then a mixture of an acid anhydride and a catalyst, or a mixture of an acid anhydride, a catalyst and a solvent is added.

The acylation of cellulose is an exothermic reaction. In the process for producing the cellulose acylate according to the invention, it is preferable to limit the maximum elevated temperature in acylation below 50° C. In case the reaction temperature is below this temperature, inconvenience such as progress of depolymerization, which would make it difficult to obtain the cellulose acylate having a degree of polymerization suitable for the use of the present invention, can be favorably prevented. The maximum elevated temperature in acylation is preferably 45° C. or less, more preferably 40° C. or less, and further preferably 35° C. or less. The reaction temperature may be controlled with a temperature controller or by the initial temperature of the acylating agent. It may also be controlled by reducing the reactor pressure to evaporate a liquid component regulating the temperature by the evaporation heat. Since heat generation is larger at the initial reaction stage of acylation, the reaction may be controlled by cooling at the initial stage and heating at a later stage. The end point of the acylation may be determined by means of light transmittance, solution viscosity, temperature change of the reaction system, solubility of the product in an organic solvent or observation under a polarization microscope.

The minimum reaction temperature is preferably −50° C. or higher, more preferably −30° C. or higher, and further preferably −20° C. or higher. The acylation time is preferably 0.5 hours to 24 hours, more preferably 1 hour to 12 hours, and further preferably 1.5 hours to 6 hours. Below 0.5 hours the reaction does not advance sufficiently under ordinary conditions, and beyond 24 hours it is disadvantageous for industrial production.

(Reaction Terminator)

It is preferable to add a reaction terminator after the acylating reaction in the producing process for the cellulose acylate according to the present invention.

Any product that decomposes an acid anhydride may be used as a reaction terminator. Preferable examples thereof include water, alcohols, such as ethanol, methanol, propanol and isopropyl alcohol, and a composition containing the same. A reaction terminator may contain a neutralizer mentioned hereinbelow. In order to evade such an inconvenience that heat generation beyond the cooling capacity of the reactor should take place by addition of a reaction terminator which would cause decrease of the degree of polymerization of the cellulose acylate, or precipitation of the cellulose acylate in an undesired shape, it is preferable, rather than to add water or alcohol directly, to add a mixture of water and a carboxylic acid, such as acetic acid, propionic acid and butyric acid, especially preferable to use acetic acid as the carboxylic acid. The mixture ratio of a carboxylic acid and water may be selected arbitrarily, but the water content in a range of 5 mass-% to 80 mass-%, further 10 mass-% to 60 mass-%, and especially 15 mass-% to 50 mass-% is preferable.

A reaction terminator may be added to a reactor for acylation, or the reaction product may be added to a container of a reaction terminator. It is preferable to add a reaction terminator over 3 min to 3 hours. In case the addition time is beyond 3 min, an inconvenience, such as too severe heat generation causing decrease of the degree of polymerization; insufficient hydrolysis of the acid anhydride; and deterioration of the stability of the cellulose acylate, will be favorably avoided. Further, in case the addition time of a reaction terminator is 3 hours or less, there will be no problem about decrease in the industrial productivity. The addition time of a reaction terminator is preferably 4 min to 2 hours, more preferably 5 min to 1 hour, and further preferably 10 min to 45 min. Although a reaction terminator may be added with or without the reactor cooling, it is preferable to cool the reactor to suppress the temperature rise in order to suppress depolymerization. Further, it is preferable to chill a reaction terminator in advance.

(Neutralizer)

In or after the acylation-termination step, a neutralizer (e.g., carbonates, acetates, hydroxides or oxides of calcium, magnesium, iron, aluminum or zinc) or a solution thereof may be added to the system for the purpose of hydrolyzing the excessive carboxylic acid anhydride remaining therein, or neutralizing a part or all of the carboxylic acid and the esterification catalyst therein. Preferable examples of a solvent for the neutralizer include water, alcohols (e.g., ethanol, methanol, propanol and isopropyl alcohol), carboxylic acids (e.g., acetic acid, propionic acid and butyric acid), ketones (e.g., acetone and ethyl methyl ketone), and other polar solvents such as dimethylsulfoxide, and mixed solvents thereof.

(Partial Hydrolysis)

The cellulose acylate thus obtained has a total degree of substitution of approximately 3, but in general for the purpose of obtaining a product having a desired substitution degree, the ester bonds of the produced cellulose acylate are partially hydrolyzed by standing in the presence of a small amount of a catalyst (generally, the remaining acylation catalyst such as sulfuric acid) and water, at 20 to 90° C. for a few minutes to a few days, so that the degree of acyl substitution of the cellulose acylate is reduced to a desired level (usually referred to as “maturation”). Since in the course of partial hydrolysis, the sulfate ester of cellulose is also hydrolyzed, by selecting the hydrolysis condition, the amount of the sulfate ester bonding to cellulose may be reduced.

It is preferable to stop the partial hydrolysis by neutralizing completely the catalyst remaining in the system with the above-mentioned neutralizer or a solution thereof, as soon as a desired cellulose acylate is obtained. It is also desirable to remove efficiently the catalyst (e.g. sulfate ester) in the reaction solution or bound to the cellulose by adding a neutralizer (e.g. magnesium carbonate and magnesium acetate) forming a salt having low solubility in the solution.

(Filtration)

It is preferable to filtrate the reaction mixture (dope) to remove or reduce unreacted materials, insoluble salts and other foreign matters in the cellulose acylate. The filtration may be conducted at any stage between the completion of acylation and reprecipitation. It is also appropriate to dilute the mixture with a suitable solvent before the filtration to control the filtration pressure or the handling property.

(Reprecipitation)

From the cellulose acylate solution thus obtained, the cellulose acylate is reprecipitated by adding the solution into a poor solvent, such as water or aqueous solution of a carboxylic acid (e.g. acetic acid, propionic acid), or admixing a poor solvent with the cellulose acylate solution, and the precipitate is washed and stabilized to obtain the object cellulose acylate. The reprecipitation may be carried out continuously or batchwise for a constant amount. It is also preferable to control the shape or the molecular weight distribution of the reprecipitated cellulose acylate, by adjusting the concentration of the cellulose acylate solution or the composition of the poor solvent depending on the substitution type or the degree of polymerization of the cellulose acylate.

(Washing)

The produced cellulose acylate should be preferably subjected to a washing treatment. Any solvent, in which the solubility of cellulose acylate is low, and which can remove impurities, may be used as a washing solvent. However, usually water or hot water is used. The temperature of washing water is preferably 25° C. to 100° C., more preferably 30° C. to 90° C., and further preferably 40° C. to 80° C. Washing may be carried out batchwise repeating filtration and change of washing liquid, or by a continuous washing apparatus. It is preferable to reuse the waste liquid generated in the steps of reprecipitation and washing as a poor solvent for the reprecipitation step, or to recover for reuse a solvent such as a carboxylic acid by means of distillation or the like.

The progress of washing may be trace by any means, and as preferable methods are exemplified hydrogen ion concentration, ion chromatography, electric conductivity, ICP, elementary analysis, and atomic absorption spectrometry methods.

By the above treatments, a catalyst (e.g. sulfuric acid, perchloric acid, trifluoroacetic acid, p-toluenesulfonic acid, methanesulfonic acid and zinc chloride), a neutralizer (e.g. a carbonate, an acetate, a hydroxide or an oxide of calcium, magnesium, iron, aluminum or zinc), a reaction product of a neutralizer and a catalyst, a carboxylic acid (e.g. acetic acid, propionic acid, butyric acid), and a reaction product of a neutralizer and a carboxylic acid in the cellulose acylate may be removed, which is effective for increasing the stability of the produced cellulose acylate.

(Stabilization)

In order to improve the stability further or to reduce the odor of a carboxylic acid, it is also preferable to treat the cellulose acylate washed by hot water with an aqueous solution of a weak alkali (e.g. a carbonate, a hydrogencarbonate, a hydroxide and an oxide of sodium, potassium, calcium, magnesium or aluminum). The amount of residual impurities may be controlled by the quantity of a washing liquid, the washing temperature and time, the stirring method and shape of the washing vessel, and the composition and concentration of the stabilizer. According to the present invention, the conditions for acylation, partial hydrolysis and washing are selected to make the residual sulfate ion concentration (as the content of sulfur atom) in a range of 0 to 500 ppm.

(Drying)

In the present invention, to control the water content of a cellulose acylate to a preferable amount, it is preferable to dry cellulose acylate. Although there is no restriction on a method of drying, insofar as a desired water content can be attained, heating, aeration, vacuum or stirring may be preferably employed singly or in combination for effective drying. The drying temperature is preferably 0 to 200° C., more preferably 40 to 180° C., and further preferably 50 to 160° C. The water content of the cellulose acylate of the present invention is preferably 2 mass-% or less, more preferably 1 mass-% or less, and further preferably 0.7 mass-% or less.

(Morphology)

Although the cellulose acylate of the present invention can be in various forms as: granule, powder, fiber and lump, as a raw material for a film production, a granular or powder form is preferable. Therefore, for homogeneous granular size and easier handling, the dried cellulose acylate may be subjected to milling or sieving. In case cellulose acylate is in a granular form, 90 mass-% or more of the granules to be used have preferably the granule size of 0.5 to 5 mm, and 50 mass-% or more of the granules to be used have preferably the granule size of 1 to 4 mm. The shape of the cellulose acylate granules is preferably as spherical as possible. The apparent density of the cellulose acylate granules of the present invention is preferably 0.5 to 1.3, more preferably 0.7 to 1.2, and further preferably 0.8 to 1.15, wherein a method for determining the apparent density is stipulated in JIS K-7365.

The angle of repose of the cellulose acylate granules of the present invention is preferably 10 to 70°, more preferably 15 to 60°, and further preferably 20 to 50°.

(Degree of Polymerization)

The degree of polymerization of the cellulose acylate to be used preferably according to the present invention is 100 to 300 (as the average degree of polymerization), preferably 120 to 250, and more preferably 130 to 200. The average degree of polymerization can be determined by a measurement according to the intrinsic-viscosity method by Uda et al. (Uda K., Saito H., Sen'i Gakkaishi, vol. 18 (1), 1962, p. 105-120), or by a measurement of the molecular weight distribution according to the gel permeation chromatography method (GPC). The details are also described in Japanese Patent Application Laid-Open No. 09-95538.

According to the present invention, the ratio of (the weight average degree of polymerization) to (the number average degree of polymerization) of the cellulose acylate according to GPC is preferably 1.6 to 3.6, more preferably 1.7 to 3.3, and further preferably 1.8 to 3.2.

A single type of the cellulose acylates may be used, or in combination of two or more types. Further a polymer component other than a cellulose acylate may be appropriately mixed. The polymer component to be mixed is preferably well compatible with a cellulose ester, and the film formed therefrom has the transmittance of 80% or higher, more preferably 90% or higher, and further preferably 92% or higher.

[Examples of Synthesis of Cellulose Acylate]

Examples of synthesis of a cellulose acylate used according to the present invention will be described in more details below, provided that the present invention should not be limited thereto.

### Synthesis Example 1

### Synthesis of Cellulose Acetate Propionate

In a 5 L-separable flask reactor with a reflux device were charged 150 g of cellulose (hard-wood pulp) and 75 g of acetic acid, which was then heated in an oil bath adjusted to 60° C. with vigorous stirring for 2 hours. The thus pretreated cellulose was swollen, opened and fluffy. The reactor was cooled in an ice-w-ater bath at 2° C. for 30 min.

An acylating agent was prepared separately as a mixture of 1,545 g of propionic anhydride and 10.5 g of sulfuric acid, which was then cooled to −30° C. and added at one time to the reactor containing the as above pretreated cellulose. After elapse of 30 min, the temperature outside the reactor was gradually raised adjusting the internal temperature to reach 25° C. at 2 hours after the addition of the acylating agent. The reactor was cooled in an ice-water bath at 5° C. adjusting the internal temperature to reach 10° C. at 0.5 hours after the addition of the acylating agent, and 23° C. at 2 hours, and then stirred for another 3 hours maintaining the inner temperature at 23° C. The reactor was cooled in an ice-water bath at 5° C. and 120 g of acetic acid containing 25 mass-% water pre-cooled to 5° C. was added over 1 hour. After raising the internal temperature to 40° C., the reactor was stirred for 1.5 hours. Then a solution of magnesium acetate tetrahydrate in an amount of 2 mol equivalent of the sulfuric acid dissolved in acetic acid containing 50 mass-% water was added to the reactor, which was then stirred for 30 min. Then 1 L of acetic acid containing 25 mass-% water, 500 mL of acetic acid containing 33 mass-% water, 1 L of acetic acid containing 50 mass-% water, and 1 L of water were added in the order mentioned to precipitate cellulose acetate propionate. The obtained precipitate of cellulose acetate propionate was washed with hot water. Thereby, by chancing the washing conditions as shown in FIG. 1l, cellulose acetate propionates with various contents of residual sulfate ion were obtained. After washing, the product was stirred in an aqueous solution of 0.005 mass-% calcium hydroxide at 20° C. for 0.5 hours, and washed further with water until the pH of the water after washing became 7, which was then dried under vacuum at 70° C.

According to measurements by ¹H-NMR and GPC, the obtained cellulose acetate propionate had the degree of acetylation of 0.30, the degree of propionylation of 2.63, and the degree of polymerization of 320. The content of sulfate ion was measured according to ASTM D-817-96.

### Synthesis Example 2

### Synthesis of Cellulose Acetate Butyrate

In a 5 L-separable flask reactor with a reflux device were charged 100 g of cellulose (hard-wood pulp) and 135 g of acetic acid, which was then left standing for 1 hour being heated in an oil bath adjusted to 60° C. Then the reactor was heated in an oil bath adjusted to 60° C. with vigorous stirring for 1 hour. The thus pretreated cellulose was swollen, opened and fluffy. The reactor was cooled in an ice-water bath at 5° C. for 1 hour to cool down the cellulose adequately.

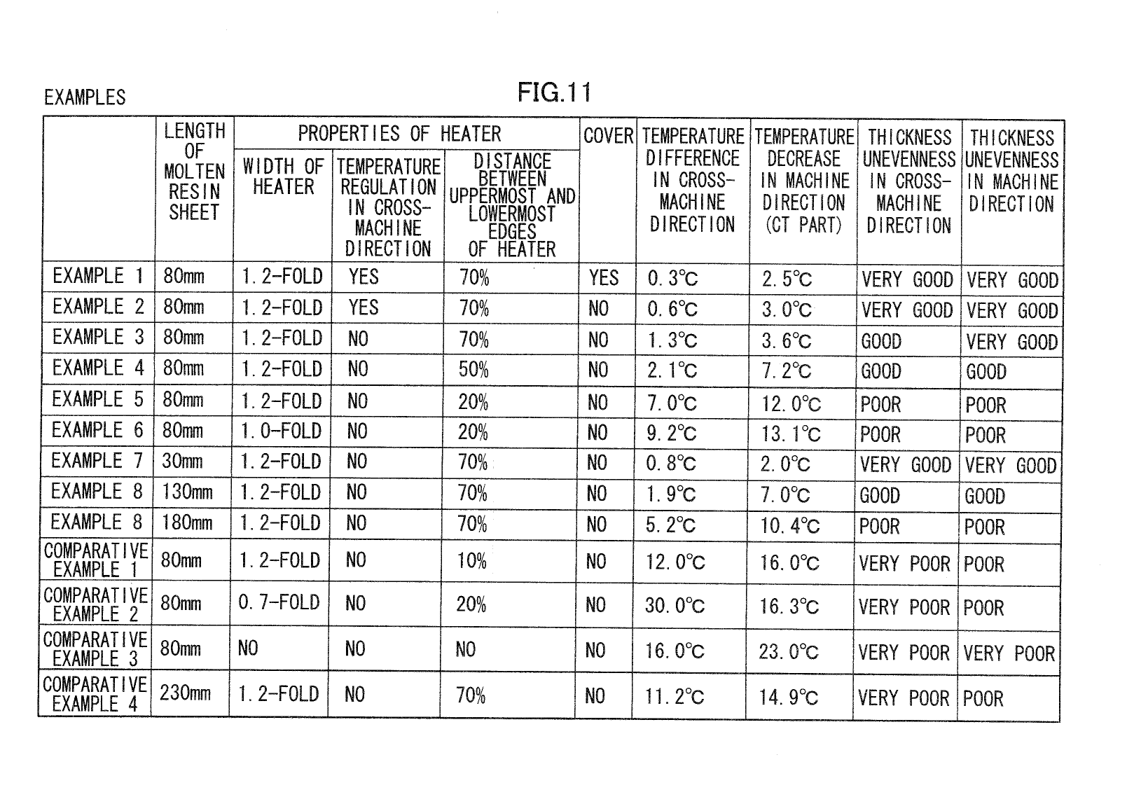

An acylating agent was prepared separately as a mixture of 1,080 g of butyric anhydride and 10.0 g of sulfuric acid, which was then cooled to −20° C. and added at one time to the reactor containing the as above pretreated cellulose. After elapse of 30 min, the temperature of an external heating device was gradually raised to 20° C. allowing reaction for 5 hours. The reactor was cooled in an ice-water bath at 5° C. and 2,400 g of acetic acid containing 12.5 mass-% water pre-cooled to approximately 5° C. was added over 1 hour. After raising the internal temperature to 30° C., the reactor was stirred for 1 hour. Then 100 g of a 50 mass-% aqueous solution of magnesium acetate tetrahydrate was gradually added to the reactor, which was then stirred for 30 min. Then 1,000 g of acetic acid and 2,500 g of acetic acid containing 50 mass-% water were added gradually to precipitate cellulose acetate butyrate. The obtained cellulose acetate butyrate was washed with hot water. Thereby, by changing the washing conditions as shown in FIG. 11, cellulose acetate butyrates with various contents of residual sulfate ion were obtained. After washing, the product was stirred in an aqueous solution of 0.005 mass-% calcium hydroxide for 0.5 hours, and washed further with water until the pH of the water after washing became 7, which was then dried under vacuum at 70° C. The obtained cellulose acetate butyrate had the degree of acetylation of 0.84, the degree of butyrylation of 2.12, and the degree of polymerization of 268.

(4) Other Additives

(i) Matting Agent

It is preferable to add fine particles as a matting agent. Example of fine particles to be used according to the present invention include silicon dioxide, titanium dioxide, aluminium oxide, zirconium oxide, calcium carbonate, calcium carbonate, talc, clay, calcined kaolin, calcined calcium silicate, hydrated calcium silicate, aluminum silicate, magnesium silicate and calcium phosphate. Particles containing silicon are preferable in view of the resulted low turbidity, and silicon dioxide is especially preferable. The silicon dioxide powder with the average primary particle size of 20 nm or less and the apparent specific gravity of 70 g/L or higher is preferable. The primary particle with a small average size of 5 to 16 nm is more preferable, because the film haze can be lowered. The apparent specific gravity is preferably 90 to 200 g/L or higher, and more preferably 100 to 200 g/L or higher. The higher the apparent specific gravity is, the higher concentration dispersion can be prepared, which is preferable in view of better haze and aggregate property.

The fine particles generally form a secondary particle with the average particle size of 0.1 to 3.0 μm, which exists in a film as an aggregate of primary particles and generates surface roughness of 0.1 to 3.0 μm. The average secondary particle size is preferably 0.2 μm to 1.5 μm, more preferably 0.4 μm to 1.2 μm, and further preferably 0.6 μm to 1.1 μm. The primary and secondary particle size were determined by observing the particles in a film with a scanning electron microscope, thereby the diameter of the circumcircle for a particle was defined as the particle size. Further thereby, 200 particles at different locations were observed and the average of the determined values was deemed as the average particle size.

Examples of the fine particles of silicon dioxide commercially available for use include Aerosil R972, R972V, R974, R812, 200, 200V, 300, R202, OX50 and TT600 (these are all manufactured by Nippon Aerosil Co., Ltd.). Examples of the fine particles of zirconium oxide commercially available for use include Aerosil R976 and R811 (manufactured by Nippon Aerosil Co., Ltd.).

Among them Aerosil 200V and Aerosil R972V are especially preferable fine particles of zirconium oxide having the average primary particle sizes of 20 nm or less, and the apparent specific gravity of 70 g/L or more, which has strong activity to lower the frictional coefficient while keeping the turbidity of an optical film low.

(ii) Miscellaneous Additives

Besides the aforementioned additives, various additives such as a UV screening agent (e.g. a hydroxybenzophenone compound, a benzotriazole compound, a salicylic acid ester compound, and a cyanoacrylate compound), an infrared absorber, an optical modifier, a surfactant, and an odor-trapping agent (amine, etc.) may be added. These materials whose details are described in Journal of Technical Disclosure (Disclosure No. 2001-1745, published on 15 Mar. 2001 by the Japan Institute of Invention and Innovation, p. 17 to 22), can be favorably utilized.

An example of an infrared absorbing dye that can be used is disclosed in Japanese Patent Application L aid-Open No. 2001-194522, and an example of a UV absorber that can be used is disclosed in Japanese Patent Laid-Open Application No. 2001-151901, and the preferable contents thereof are respectively 0.001 to 5 mass-% with respect to a cellulose acylate.

As an optical modifier, a retardation modifier may be exemplified, and those disclosed in Japanese Patent Application Laid-Open No. 2001-166144, Japanese Patent Application Laid-Open No. 2003-344655, Japanese Patent Application Laid-Open No. 2003-248117 and Japanese Patent Application Laid-Open No. 2003-66230 can be used to adjust the in-plane retardation (Re) and the thickness-direction retardation (Rth). The addition amount is preferably 0 to 10 wt %, more preferably 0 to 8 wt %, and further preferably 0 to 6 wt %.

(5) Physical Properties of Cellulose Acylate Composition

The cellulose acylate composition (mixture of cellulose acylate, a plasticizer, a stabilizer and other additives) should preferably satisfy the following requirements concerning the physical properties.

(i) Weight Loss

The weight loss rate on heating at 220° C. of the thermoplastic cellulose acetate propionate composition of the present invention is 5 weight-% or less. Thereby the weight loss rate on heating refers to the rate of weight loss of a sample at 220° C., when the sample temperature is increased from room temperature at a temperature-increase rate of 10° C./min under a nitrogen atmosphere. Formulating the cellulose acylate composition, the weight loss rate on heating can be decreased to 5 weight-% or below. It is more preferably 3 weight-% or below, and further preferably 1 weight-% or below. Owing to the above, the trouble (bubbling) during film formation can be suppressed.

(ii) Melt Viscosity

The melt viscosity (at 220° C., 1 sec⁻¹) of the thermoplastic cellulose acetate propionate composition of the present invention is preferably 100 to 1,000 Pa·sec, more preferably 200 to 800 Pa·sec, and further preferably 300 to 700 Pa·sec. At this high level of melt viscosity, stretching by a tension at the die outlet does not occur, so that increase of the optical anisotropy (retardation) due to orientation by stretching can be avoided. For adjustment of the melt viscosity, any method may be applied, and is attainable, for example, by adjusting the degree of polymerization of the cellulose acylate or the addition amount of the plasticizer.

(6) Pelletization

The cellulose acylate and additives are preferably mixed and pelletized prior to the melt casting film formation.

Although it is preferable to dry the cellulose acylate and additives prior to pelletization, it may be omitted by using a vented extruder. In case drying is conducted, a method that the material is heated in an oven at 90° C. for 8 hours or longer, is applicable, but not limited thereto. Pelletization can be done by melting the cellulose acylate and additives by a twin screw kneading extruder at 150° C. to 250° C. and extruding strands like noodles, which are solidified in water and then cut to pellets. An under-water cut pelletizing method is also applicable, by which the melt being extruded directly from the die into water is cut to pellets.

Insofar as melting and kneading is sufficiently performed, any publicly known extruder, such as a single screw extruder, a non-intermeshing and counter-rotating twin screw extruder, an intermeshing and counter-rotating twin screw extruder and an intermeshing and co-rotating twin screw extruder, may be used.

Concerning the size of the pellet, preferably the cross-section is 1 mm² to 300 mm² and the length is 1 mm to 30 mm, more preferably the cross-section is 2 mm² to 100 mm² and the length is 1.5 mm to 10 mm.

By pelletization, the additives may be fed through a feeding port located at the middle part of the extruder or a venting port.

The rotating speed of the extruder is preferably 10 rpm to 1,000 rpm, more preferably 20 rpm to 700 rpm, and further preferably 30 rpm to 500 rpm. In case the rotating speed is below the above range, the residence time becomes too long and due to thermal degradation the molecular weight may be decreased and yellowish discoloration may occur unfavorably. In case the rotating speed is too high, scissions of molecules by shearing are increased, which generates problems, such as decrease of the molecular weight, or increase of gel generation by cross-linking.

The extruder residence time by pelletization is 10 sec to 30 min, more preferably 15 sec to 10 min, and further preferably 30 sec to 3 min. Insofar as sufficient melting can be attained, a shorter residence time is preferable, because deterioration of the resin and discoloration can be minimized.

(7) Melt-Casting Film Formation

(i) Drying

Preferably, the pellet prepared as above is used, whose water content is preferably lowered prior to film melt-casting.

To control the water content of the cellulose acylate according to the present invention at a desired level, it is preferable to dry the cellulose acylate. Although a dehumidified air dryer is frequently used, there is no particular restriction on a drying method, insofar as the desired water content can be attained. It is preferable to use such means as heating, aeration, vacuuming and stirring, singly or in combination for efficient dying, and further preferable to construct a dying hopper with an insulated structure. The drying temperature is preferably 0 to 200° C., more preferably 40 to 180° C., and further preferably 60 to 150° C. Too low drying temperature is not preferable, because drying requires a longer time period and the desired water content may not be reached. Reversely, too high drying temperature may cause blocking by adhesion of the resin. The air flow rate is preferably 20 to 400 m³/hour, more preferably 50 to 300 m³/hour, and further preferably 100 to 250 m³/hour. Too low air flow rate is not preferable due to low drying efficiency. The flow rate beyond a certain limit is uneconomic, because improvement of the drying efficiency flattens. The dew point of the air is preferably 0 to −60° C., more preferably −10 to −50° C., and further preferably −20 to −40° C. The drying time requires at least 15 min, more preferably 1 hour or longer, and further preferably 2 hours or longer. On the other hand drying beyond 50 hours, the additional decreasing effect of the water content is minimal, while there arises a fear of thermal deterioration of the resin. Therefore too long drying is not preferable. The water content of the cellulose acylate of the present invention is preferably 1.0 mass-% or less, more preferably 0.1 mass-% or less, and further preferably 0.01 mass-% or less.

(ii) Melt Extrusion

The cellulose acylate is fed through a feeding port into a cylinder of an extruder (different from the extruder for pelletization). In the cylinder are arranged a feed zone (zone A), where the cellulose acylate resin fed from the feeding port is transported constantly, a compression zone (zone B), where the cellulose acylate resin is kneaded and compressed and a metering zone (zone C), where the kneaded and compressed cellulose acylate resin is metered, from the feeding port side in the mentioned order. The resin is preferably dried according to the aforedescribed method to decrease the water content, and further, to prevent oxidation of the molten resin by residual oxygen, an operation either with an inert gas (e.g. nitrogen) sweeping inside the extruder, or with vacuum evacuation using a vented extruder is preferable. The compression ratio of the extruder screw is set at 2.5 to 4.5, and L/D is set at 20 to 70. Thereby the screw compression ratio represents a volume ratio of the feed zone A to the metering zone C, namely represents the quotient of (a volume of the feed zone A per unit length) by (a volume of the metering zone C per unit length) and is calculated using the outer diameter d1 of the screw shaft in the feed zone A, the outer diameter d2 of the screw shaft in the metering zone C, the channel depth a1 in the feed zone A, and the channel depth a2 in the metering zone C. Further, L/D represents the ratio of the cylinder inner diameter to the cylinder length. The extruding temperature is set at 190 to 240° C. If the temperature in the extruder exceeds 240° C., it is preferable to install a cooler between the extruder and the die.

If the screw compression ratio is so small as below 2.5, kneading becomes insufficient which may lead to generation of unmolten solids, to insufficient generation of the shearing heat to cause insufficient melting of crystals, leaving minute crystallites in the produced cellulose acylate film, and further to vulnerability to bubble mixing. In such event, the cellulose acylate film having decreased strength is produced, or when a cellulose acylate film is stretched, the remaining crystallites would deteriorate stretchability leading to poor orientation. On the contrary, if the screw compression ratio is so large as above 4.5, heat generation by too high shearing force could lead to possible deterioration of the resin and yellowish discoloration of the produced cellulose acylate film. Further too high sharing stress could cause molecular scission lowering the molecular weight and the mechanical strength of the film. Consequently to prevent yellowish discoloration of the produced cellulose acylate film and breakage during stretching, the screw compression ratio is preferably in a range of 2.5 to 4.5, more preferably in a range of 2.8 to 4.2, and further preferably in a range of 3.0 to 4.0.

If L/D is so small as below 20, insufficient melting or insufficient kneading can take place, and as in the case of too small compression ratio, minute crystallites tend to remain in a produced cellulose acylate film. Reversely, if L/D is so large as beyond 70, the residence time of the cellulose acylate resin in the extruder becomes too long, and the resin becomes vulnerable to deterioration. The longer residence time leads to molecular scission to lower the molecular weight and mechanical strength of the film. Consequently to prevent yellowish discoloration of the produced cellulose acylate film and breakage during stretching, the L/D is preferably in a range of 20 to 70, more preferably in a range of 22 to 65, and further preferably in a range of 24 to 50.

The extrusion temperature is preferably set at the temperature range described above. The cellulose acylate film thus obtained has such characteristic values as: the haze of 2.0% or less, and the yellow index (Y1 value) of 10 or less.

Wherein, the haze can be an index to show whether the extrusion temperature is too low, in other words, an index to show the quantity of crystallites remaining in the produced cellulose acylate film. If the haze exceeds 2.0, decrease of the strength of the produced cellulose acylate film, and breakage during stretching tend to occur more frequently. While, the yellow index (YI) can be an index to show whether the extrusion temperature is too high. If the yellow index (YI) is 10 or below, there is no concern about yellowness.

Concerning the type of an extruder, a single screw extruder is more frequently used owing to its relatively low equipment cost. Among various screw types, such as full flight-, Maddock- and Dulmage-type, the full flight type is preferable in view of rather poor thermal stability of the cellulose acylate resin. On the other hand, although the equipment cost being higher, a twin screw extruder may be used, which screw segment may be rearranged to place a venting port capable of venting out unnecessary volatile matters, while extrusion is in progress. The twin extruder may be classified into 2 large groups of a co-rotating type and a counter-rotating type. Although both types can be used, the co-rotating type is preferable, because a stasis space is hardly formed and self-cleaning activity is high. Although the equipment cost is high, since kneading capability is high, resin supplying capacity is high and extrusion at lower temperature is possible, the twin screw extruder is suitable for film formation of the cellulose acetate resin. Placing a venting port appropriately, the cellulose acylate pellet or powder without drying may be used for the extrusion. Further, direct reuse of a trim generated in the film formation process without pre-dying is possible.

Although the preferable screw diameter varies depending on the desired extrusion amount per unit time, it is in a range of 10 mm to 300 mm, more preferably 20 mL to 250 mm, and further preferably 30 mm to 150 mm.

(iii) Filtering

It is preferable to conduct filtering by a so-called breaker-plate with a filter medium at the discharge port of the extruder to eliminate foreign matters in the resin and to avoid damages on a gear pump by foreign matters. Furthermore, to remove foreign matters at higher accuracy, it is preferable to install a filter mounted with so-called leaf disc filter elements after the gear pump. Filtering may be conducted by a single-stage filter installed at one location or by multi-stage filters installed at several locations. Although higher filtration accuracy is desirable, from the constraints of the pressure resistance of the filtering medium and increase of the filtration pressure by clogging of the filtering medium, the filtration accuracy is preferably 15 μm to 3 μm, and more preferably 10 μm to 3 μm. In case a filter with leaf disc filter elements is used as a final filter of foreign matters, a filtering medium with the quality of high filtration accuracy is preferably used, and to assure the requirements of pressure resistance and durability of the filter, the number of the mounted filter elements may be adjusted. In view of the use under high temperature and high pressure, the material of the filtering medium is preferably a ferrous material, among ferrous materials preferably a stainless steel or a steel, especially preferably a stainless steel in view of the corrosion stability. Concerning the structure of the filtering medium, a woven wire medium and a sintered medium prepared by sintering long metallic fibers or metallic powders can be used, and the sintered filter is preferable in view of the filtration accuracy and the filter durability.

(iv) Gear Pump

To improve the thickness accuracy of a film, it is important to reduce the fluctuation of the extrusion rate, and it is effective to provide a gear pump between the extruder and the die, so that the cellulose acylate resin can be supplied at a constant rate. The gear pump is composed of a pair of gears, a driving gear and a driven gear, engaged each other and mounted in a housing. When the driving gear is driven, the engaged driven gear is rotated together to suck the molten resin into the cavity of the pump through a suction port formed in the housing and the molten resin is extruded at a constant rate from a delivery port formed in the housing. Even if the resin pressure at the outlet of the extruder fluctuates slightly, a gear pump absorbs such fluctuation and the pressure fluctuation at a downstream section of the film formation equipment becomes minimal and the thickness accuracy is improved. By use or a gear pump, the fluctuation of the resin pressure at the die can be controlled within ±1%.

In order to improve the flow rate constancy of a gear pump, a method may be applied, by which the pressure before the gear pump is regulated to a constant level by changing the rotation speed of the screw. Alternatively, a high accuracy gear pump having 3 or more gears to overcome the fluctuation of the gears may be effectively used.

Another advantage of the use of a gear pump is that the film formation is possible with the lower pressure at the screw head, by which saving of energy consumption, prevention of the resin temperature increase, improvement of transportation efficiency, reduction of the residence time in the extruder, and curtailment of L/D of the extruder can be expected. In case a filter is used to remove foreign matters, with the increase of the filtration pressure the supply rate of the resin from the extruder may change, which can be avoided if a gear pump is used together. Care should be taken concerning such disadvantages of the gear pump that the facility length and the residence time of the resin may become long depending on the selection of the equipment, or that scissions of the molecular chains may be caused by the shearing force of a gear pump.

The residence time of the resin from the incoming of the resin into the extruder through the feeding port until the outgoing through the die is preferably 2 min to 60 min, more preferably 3 min to 40 min, and further preferably 4 min to 30 min.

When the flow of a polymer circulating through the bearing of a gear pump is disturbed, the sealing by the polymer at a driving section and the bearing section may be compromised, and such troubles as increase of fluctuations in the flow rate or the delivery pressure may be caused. To cope with such problems, designing of the gear pump (especially clearance) specific to the melt viscosity of the cellulose acylate resin is required. Further, since a stasis space in the gear pump may cause degradation of the cellulose acylate resin, a structure with least stasis space is preferable. The polymer piping or adapters used for connecting the extruder and the gear pump, or the gear pump and the die, should be designed to minimize such stasis spaces, as well as to minimize the temperature fluctuation, so that the extrusion pressure of the cellulose acylate resin having the highly temperature dependent melt viscosity can be stabilized. Although a band heater with low equipment cost is used generally for heating the polymer piping, it is more preferable to use a cast aluminum heater with less temperature fluctuation. Furthermore, for the sake of stabilization of the extrusion pressure of the extruder, the barrel of the extruder should be preferably heated for melting by a heater divided into 3 to 20 segments.

(v) Die

A cellulose acylate resin is molten by the extruder having the aforementioned structure and continuously fed to the die through, as the case may be, a filter and a gear pump. Insofar as designed with little stasis of the molten resin in the die, any of a commonly used T-die, a fish-tale die and a coat-hanger die can be used. Furthermore, a static mixer may be installed just before the T-die to improve the temperature uniformity of the resin. The clearance at the outlet of the T-die is in general 1.0 to 5.0-fold the film thickness, preferably 1.2 to 3-fold, and more preferably 1.3 to 2-fold. In case the lip clearance is 1.0-fold or less the film thickness, it is difficult to obtain a film of good planar quality. On the contrary, in case the lip clearance is 5.0-fold or more the film thickness, the accuracy of the film thickness is unfavorably compromised. Since the die is an extremely important equipment to determine the thickness accuracy of the film, it is preferable to employ a die capable of severely controlling the thickness. The thickness of a film can be controlled by a die in general at a pitch of 40 mm to 50 mm, but a die capable of regulating the film thickness preferably at a pitch of 35 mm or less, more preferably at a pitch of 25 mm or less, is preferable. Since the melt viscosity of the cellulose acylate is highly dependent on temperature and shear rate, it is important to design a die to minimize the temperature fluctuation and the flow rate cross-machine fluctuation of the die. Furthermore, a die equipped with an automatic thickness regulator is known, with which the downstream film thickness is measured and the deviation of the thickness is calculated, and by feedback of the same the die is regulated for a constant thickness. The use of a die equipped with such regulator is advantageous to decrease the thickness fluctuation in a long-time continuous production.

(vi) Casting

The molten resin is extruded as above from the die in a form of a sheet on to chill drums. In this occasion the thickness difference in a cross-machine direction can be adjusted by regulating the lip clearance of the die.

Thereby it is necessary to nip the sheet for cooling and solidifying by a pair of the metallic rolls having the surface property of the arithmetic average roughness Ra of 100 nm or less. Use of chill rolls with the surface property of the arithmetic average roughness Ra beyond 100 nm is not preferable, because the transparency of the film is compromised. The roughness Ra is preferably 50 nm or less, and more preferably 25 nm or less.

The temperature of the chill drums is preferably 60° C. to 190° C., more preferably 70° C. to 150° C., and further preferably 80° C. to 140° C. The sheet is stripped off from the chill drum and wound up after passing a drawing roll (nip roll). The winding speed is preferably 10 m/min to 100 m/min, more preferably 15 m/min to 80 m/min, and further preferably 20 rn/min to 70 m/min.

The film formation width is preferably 0.7 m to 5 m, more preferably 1 m to 4 m, and further preferably 1.3 m to 3 m. The thickness of the thus obtained unstretched film is preferably 30 μm to 400 μm, more preferably 40 μm to 300 μm, and further preferably 50 μm to 200 μm.

In case a touch roll method is employed, the surface material of the touch roll may be a resin, such as rubber and Teflon (registered trade name), or a metal. Furthermore, a so-called flexible roll may be used, which is a metallic roll with a very thin wall and which surface is deformed slightly in a concave form increasing the contact area by the touching pressure.

The temperature of the touch roll is preferably 60° C. to 160° C., more preferably 70° C. to 150° C., and further preferably 80° C. to 140° C.

(vii) Winding

The sheet thus obtained is preferably trimmed at both the edges and wound up. The trim may be after crushing or, if necessary, being subjected to a treatment, such as pelletizing, depolymerization, and repolymerization, reused as a raw material for the same or different type of the film. Any type of the cutter may be used for trimming including a rotary cutter, a shear blade and a knife. Concerning the material therefor, either of a carbon steel and a stainless steel can be used. In general a carbide blade and a ceramic blade are preferable, because they have long blade durability and generate less blade chips.

It is preferable to laminate a film on at least one surface before winding in view of protection against physical damages. The winding tension is preferably 1 kg/m width to 50 kg/m-width, more preferably 2 kg/m-width to 40 kg/m-width, and further preferably 3 kg/m-width to 20 kg/m-width. In case the winding tension is below 1 kg/m-width, uniform winding of the film is difficult. Reversely, in case the winding tension is beyond 50 kg/m-width, it will lead to unfavorable tight winding of the film, which not only deteriorates the appearance of the film reel, but also elongates the film at a bulge of the reel by creeping to cause waving of the film or generation of residual birefringence by the film elongation. It is preferable to detect the winding tension by the on-line tension controller and to wind up the film controlling the winding tension at a constant level. In case there is a difference in the film temperature locationwise in the film formation line, the film length may be slightly different due to thermal expansion, therefore the draw rate between the nip rolls should be adjusted, so that the determined film tension limit be not exceeded at any part of the line.

Although it is possible to wind up the film with a constant winding tension under a control of a tension controller, it is more preferable to change the tension gradually adapting appropriately to the wound reel diameter. In general, with the increase of the wound reel diameter, the tension is gradually decreased. However, in some cases, with the increase of the wound reel diameter, the tension should better be increased.

(viii) Physical Properties of Unstretched Film of Cellulose Acylate

Putting the slow axis in the machine direction of the film, the thus obtained unstretched film of a cellulose acylate has preferably Re=0 to 20 nm and Rth=0 to 20 nm, wherein Re represents in-plane retardation, and Rth represents thickness-direction retardation. Re is measured by KOBRA 21 ADH (Oji Scientific Instruments) with the incident light along the normal line of the film. Rth is calculated based on retardation values measured in total three directions. One is the Re and others are retardation values measured with an incident light at an tilted angle of +40° and −40° relative to the normal line of the film, by tilting around the rotation axis which is fit to the in-plane slow axis. The angle (θ) between the machine direction (longitudinal direction) and the slow axis of Re of the film is preferably as close to 0°, +90° or −90° as possible.

The light transmission is preferably 90% to 100%, more preferably 91% to 99%, and further preferably 92% to 98%. The haze is preferably 0 to 1%, more preferably 0 to 0.8%, and further preferably 0 to 0.6%.

The thickness unevenness is both in the machine direction and in the cross-machine direction preferably 0% to 4%, more preferably 0% to 3%, and further preferably 0% to 2%.

The tensile modulus is preferably 1.5 kN/mm² to 3.5 kN/mm², more preferably 1.7 kN/mm² to 2.8 kN/mm², and further preferably 1.8 kN/mm² to 2.6 kN/mm².

The fracture elongation is preferably 3% to 100%, more preferably 5% to 80%, and further preferably 8% to 50%.

The Tg of the film (namely, Tg of the mixture of a cellulose acylate and additives) is preferably 95° C. to 145° C., more preferably 100° C. to 140° C., and further preferably 105° C. to 135° C.

The thermal dimensional change at 80° C. per day is both in the machine direction and in the cross-machine direction preferably 0% or higher±1% or less, more preferably 0% or higher±0.5% or less, and further preferably 0% or higher±0.3% or less.

The water permeability at 40° C. and 90% RH is preferably 300 g/(m²·day) to 1,000 g/(m²·day), more preferably 400 g/(m²·day) to 900 g/(m²·day), and further preferably 500 g/(m²·day) to 800 g/(m²·day).

The equilibrium water content at 25° C. and 80% RH is preferably 1 wt % to 4 wt %, more preferably 1.2 wt % to 3 wt %, and more preferably 1.5 wt % to 2.5 wt %.

(8) Stretching

The film formed as above may be stretched, so that Re and Rth can be regulated.

Stretching is carried out preferably at Tg to Tg+50° C., more preferably at Tg+3° C. to Tg+30° C., and more preferably Tg+5° C. to Tg+20° C. The stretching ratio is at least in one direction preferably 1% to 300%, more preferably 2% to 250%, and further preferably 3% to 200%. Although stretching may be carried out both in the machine direction and in the cross-machine direction, it is more preferable to stretch anisotropically obtaining a larger stretching ratio for one direction. Either of the machine direction (MD) stretching ratio or the transverse direction (TD) stretching ratio may be larger. The smaller stretching ratio is preferably 1% to 30%, more preferably 2% to 25%, and further preferably 3% to 20%. The larger stretching ratio is preferably 30% to 300%, more preferably 35% to 200%, and further preferably 40% to 150%. The stretching may be carried out at a single stage, or at multiple stages. The stretching ratio hereunder is determined by the following formula.

Stretching ratio(%)=100×[(length after stretching)−(length before stretching)]/(length before stretching)

Such stretching may be carried out by stretching in the machine direction with 2 or more pairs of nip rolls, which downstream rolls rotates at a higher circumferential velocity (machine direction stretching), or by spreading the film in the cross-machine direction (orthogonally to the machine direction) by gripping both the film side by means of a chuck (cross-machine direction stretching). Stretching may be carried out in two directions simultaneously according to the method described in Japanese Patent Application Laid-Open No. 2000-37772, Japanese Patent Application Laid-Open No. 2001-113591, and Japanese Patent Application Laid-Open No. 2002-103445.

In case of machine direction stretching, the ratio of Re to Rth can be freely controlled by controlling the ratio of the length between the nip rolls to the film width (length/width ratio). By decreasing the length/width ratio, the Rth/Re ratio can be increased. Furthermore, by combining the machine direction stretching and the cross-machine direction stretching, Re and Rth can be controlled. More specifically, by decreasing the difference between the machine direction stretching ratio and the cross-machine direction stretching ratio, Re can be decreased, and reversely by increasing the difference, Re can be increased.

Re and Rth of the stretched cellulose acylate film preferably satisfy the following formulas.

Rth≧Re

500≧Re≧0

500≧Rth≧30

more preferably,

Rth≧Re×1.1

150≧Re≧10

400≧Rth≧50

further preferably,

Rth≧Re×1.2

100≧Re≧20

350≧Rth≧80

The angle (θ) between the machine direction and the slow axis of Re of the film is preferably as close to 0°, +90° or −90° as possible. More particularly, in case of machine direction stretching, the θ is preferably close to 0°, preferably 0±3°, more preferably 0±2°, and further preferably 0±1°. In case of cross-machine direction stretching, the θ is preferably 90±3° or −90±3°, more preferably 90±2° or −90±2°, and further preferably 90±1° or −90±1°.

The thickness unevenness of the stretched cellulose acylate film is both in the machine direction and in the cross-machine direction preferably 0% to 3%, more preferably 0% to 2%, and further preferably 0% to 1%.

The physical properties of the stretched cellulose acylate film are preferably in the following ranges.

The tensile modulus is preferably 1.5 kN/mm² to 3.0 kN/mm², more preferably 1.7 kN/mm² to 2.8 kN/mm², and further preferably 1.8 kN/mm² to 2.6 kN/mm².

The fracture elongation is preferably 3% to 100%, more preferably 5% to 80%, and further preferably 8% to 50%.

The Tg of the film (namely, Tg of the mixture of a cellulose acylate and additives) is preferably 95° C. to 145° C., more preferably 100° C. to 140° C., and further preferably 105° C. to 135° C.

The thermal dimensional change at 80° C. per day is both in the machine direction and in the cross-machine direction preferably 0% or higher±1% or less, more preferably 0% or higher±0.5% or less, and further preferably 0% or higher±0.3% or less.

The water permeability at 40° C. and 90% is preferably 300 g/(m²·day) to 1,000 g/(m²·day), more preferably 400 g/(m²·day) to 900 g/(m²·day), and further preferably 500 g/(m²·day) to 800 g/(m²·day).

The equilibrium water content at 25° C. and 80% RH is preferably 1 wt % to 4 wt %, more preferably 1.2 wt % to 3 wt %, and further preferably 1.5 wt % to 2.5 wt %.

The thickness is preferably 30 μm to 200 μm, more preferably 40 μm to 180 μm, and further preferably 50 μm to 150 μm.

The haze is preferably 0% to 2.0%, more preferably 0% to 1.5%, and further preferably 0% to 1%.

The light transmission is preferably 90% to 100%, more preferably 91% to 99%, and further preferably 92% to 98%.

(9) Surface Treatment

The unstretched or stretched cellulose acylate film can be improved in adhesion to various functional layers, such as a priming layer and a backing layer, by conducting a surface treatment. Examples of the applicable surface treatment include a glow discharge treatment, a UV irradiation treatment, a corona treatment, a flame treatment and an acid or alkali treatment. The glow discharge treatment may be a treatment by low-temperature plasma generated under a low gas pressure of 10⁻³ to 20 Torr or by plasma under the atmospheric pressure. A plasma excitation gas is a gas which can be excited to plasma under the aforementioned conditions, and examples thereof include argon, helium, neon, krypton, xenon, nitrogen, carbon dioxide, frons such as tetrafluoromethane, and mixtures thereof. Further details thereof are described in Journal of Technical Disclosure (Disclosure No. 2001-1745, published on 15 Mar. 2001 by the Japan Institute of Invention and Innovation, p. 30 to 32). In the atmospheric plasma treatment, which has recently drawn attention, irradiation energy of 20 to 500 kGy is applied under the conditions of 10 to 1,000 keV, more preferably irradiation energy of 20 to 300 kGy under the conditions of 30 to 500 keV is applied. Among others, the alkali saponification treatment is especially preferable, and an very effective surface pretreatment method for the cellulose acylate film. Details described in Japanese Patent Application Laid-Open Nos. 2003-3266, 2003-229299, 2004-322928 and 2005-76088 can be applicable.

The alkali saponification treatment may be conducted by dipping into a saponification liquid or by coating the same. In case of a dipping method, a film is dipped in a vessel containing an aqueous solution of NaOH or KOH (pH 10 to 14) heated to 20° C. to 80° C. passing through over 0.1 to 10 min, and then neutralized, washed with water and dried to complete the treatment.

In case of a coating method, such a method as a dip-coating method, a curtain coating method, an extrusion coating method, a bar coating method and an E-type coating method may be employed. A solvent of choice for the alkali saponification coating solution should preferably have good wettability in order to coat the saponification solution onto a transparent substrate and maintains the flat surface property without forming unevenness on the transparent substrate surface by the saponification solvent. More specifically, an alcoholic solvent is preferable and isopropyl alcohol is particularly preferable. Alternatively, an aqueous solution of a surfactant may be used as a solvent. The alkali of the alkali saponification coating solution is preferably dissolved in the aforementioned solvent, and KOH and NaOH are further preferable. The pH of the saponification coating solution is preferably 10 or higher, and more preferably 12 or higher. The alkali saponification reaction is preferably performed at room temperature for 1 sec to 5 min, more preferably for 5 sec to 5 min, and further preferably for 20 sec to 3 min. After the alkali saponification reaction, the surface coated with the saponification solution is preferably washed with water or an acid followed by washing with water. The saponification coating treatment and the removal of a coat from an orientation film (described herein below) can be continuously performed to reduce the number of production steps. The saponification methods are more specifically described in Japanese Patent Application Laid-Open No. 2002-82226 and WO-02/46809.

It is preferable to make a primer layer for adhesion with a functional layer. A primer layer may be coated after the surface treatment or without the surface treatment. The details of a primer layer are described in Journal of Technical Disclosure (Disclosure No. 2001-1745, published on 15 Mar. 2001 by the Japan Institute of Invention and Innovation, p. 32).

The surface treatment and the priming step may by integrated in the last stage of the film forming process, or conducted independently, or conducted in the functional layer forming process (described below).

(10) Functional Layer Forming

It is preferable that the stretched or unstretched cellulose acylate film according to the present invention is combined with functional layers described in details in Journal of Technical Disclosure (Disclosure No. 2001-1745, published on 15 Mar. 2001 by the Japan Institute of Invention and Innovation, p. 32-45). Among others, it is preferable to form a polarizing layer (polarizer), an optical compensation layer (optical compensation film), an antireflection layer (anti-reflective film) and a hard coat layer.

(i) Polarizing Layer Forming (Formation of a Polarizer)

### [Materials to be Used for a Polarizing Layer]

A polarizing layer presently on the market is generally formed by dipping a stretched polymer in a solution of iodine or a dichroic dye in a bath, which permeates to a binder in it. Alternatively, a polarizing membrane formed by coating, for example, of a product by Optiva Inc. may be used. The iodine and dichroic dye in the polarizing membrane are oriented in the binder to express polarizing activity. Examples of the dichroic dye include an azo dye, a stilbene dye, a pyrazolone dye, a triphenylmethane dye, a quinoline dye, an oxazine dye, a thiazine dye and an anthraquinone dye. The dichroic dye is preferably water-soluble and preferably has a hydrophilic substituent such as sulfo, amino, and hydroxyl groups. More specifically, a compound described in Journal of Technical Disclosure (Disclosure No. 2001-1745, published on 15 Mar. 2001 by the Japan Institute of Invention and Innovation, p. 58) may be exemplified.

As the binder of the polarizing membrane, both a self-crosslinkable polymer and a polymer crosslinkable by a cross-linking agent may be used, and further a plurality of combinations thereof may be used. Examples of the binder include a methacrylate copolymer, a styrene copolymer, a polyolefin, a polyvinyl alcohol, a modified polyvinyl alcohol, poly(N-methylolacrylamide), a polyester, a polyimide, a vinyl acetate copolymer, a carboxymethylcellulose, and a polycarbonate, as described, for example, in Japanese Patent Application Laid-Open No. 08-338913 (DESCRIPTION, Paragraph [0022]). A silane coupling agent can be also used as a polymer. As the binder are preferable a water-soluble polymer, such as poly(N-methylolacrylamide), a carboxymethylcellulose, gelatin, a polyvinyl alcohol and a modified polyvinyl alcohol; more preferable gelatin, a polyvinyl alcohol and a modified polyvinyl alcohol; and further preferable a polyvinyl alcohol and a modified polyvinyl alcohol. Particularly preferably, two types of polyvinyl alcohols or modified polyvinyl alcohols different in the degrees of polymerization are used in combination. The degree of saponification of polyvinyl alcohol is preferably 70 to 100%, and more preferably 80 to 100%. The degree of polymerization of a polyvinyl alcohol is preferably 100 to 5,000. The modified polyvinyl alcohol is described in Japanese Patent Application Laid-Open Nos. 08-338913, 09-152509 and 09-316127. Two or more types of polyvinyl alcohols and modified polyvinyl alcohols may be used in combination.

The lower limit of the thickness of the binder is preferably 10 μm. As for the upper limit, the thinner binder is the better in view of light leakage from a liquid crystal display device. Therefore, the binder thickness is preferably equal to or thinner than a polarizer now on the market (about 30 μm), more preferably 25 μm or less, and further preferably 20 μm or less.

The binder of the polarizing membrane may be crosslinked. A polymer or monomer having a crosslinkable functional group may be mixed with the binder, or a crosslinkable functional group may be introduced to the binder polymer. Crosslinking may be initiated by light, heat or pH change to form a binder having a crosslinked structure. Concerning a crosslinking agent, there is a description in the specification of U.S. Reissued Pat. No. 23297. Alternatively, a boron compound such as boric acid and borax may be used as a crosslinking agent. The addition amount of a crosslinking agent is preferably 0.1 to 20 mass-% with respect to the binder, so that the orientation of a polarizing element and the wet-heat resistance of the polarizing membrane can be favorable.

After completion of the crosslinking reaction, the unreacted crosslinking agent is preferably 1.0 mass-% or less, and more preferably 0.5 mass-% or less, so that the weather resistance can be improved.

### [Stretching of Polarizing Membrane]

A polarizing membrane is preferably stained with iodine or a dichroic dye after stretching (a stretching method) or rubbing (a rubbing method) of the polarizing membrane.

In the stretching method, the stretching ratio is preferably 2.5 to 30.0, and more preferably 3.0 to 10.0. Stretching may be conducted in the air (dry stretching) or dipped in water (wet stretching). The stretching ratio is preferably 2.5 to 5.0 by the dry stretching, and 3.0 to 10.0 by the wet stretching. The stretching may be performed parallel to the machine direction (parallel stretching) or diagonally (diagonal stretching). Such stretching may be performed in a single stage or dividedly in several stages. Stretching conducted in multiple stages is advantageous for a high stretching ration, because the membrane can be stretched still uniformly. More preferable is the diagonal stretching with the tilt angle of 10° to 80°.

(I) Parallel Stretching

Prior to stretching, a PVA film is swollen. The degree of swelling is 1.2 to 2.0 (the mass ratio after swelling to before swelling). Thereafter, the PVA film is transported continuously by means of guide rolls and the like into a bath containing an aqueous medium or a dyeing bath containing a dichroic dye, in which the PVA film is stretched at a bath temperature of 15 to 50° C., preferably 17 to 40° C. Stretching is conducted by nipping the film by two pairs of nip rolls and by rotating the nip rolls such that the downstream pair of nip rolls transport the film faster than the upstream rolls. The stretching ratio means hereinafter the ratio of (the length after stretching) to (the length before stretching), which is preferably in view of the functional effects mentioned above 1.2 to 3.5, and more preferably 1.5 to 3.0. Thereafter by drying at 50° C. to 90° C. a polarizing membrane can be obtained.

(II) Diagonal Stretching

A diagonal stretching method using a tenter extending in the diagonal direction described in Japanese Patent Application Laid-Open No. 2002-86554 may be applied. According to the method a film is stretched in air, and therefore the film must be treated in advance to contain water to improve the stretchability. The water content of the film is preferably 5% to 100%. The stretching temperature is preferably 40° C. to 90° C. and the air humidity during stretching is preferably 50% RH to 100% RH.

The absorption axis of the polarizing membrane thus obtained is preferably 10° to 80°, more preferably 30° to 60°, and further preferably substantially 45° (400° to 50°).

[Lamination]

A polarizer is prepared by laminating a saponified stretched or unstretched cellulose acylate film and a polarizing layer prepared by stretching. Although there is no particular restriction on direction for lamination, it is preferable to orient the stretching direction of a polarizer at any one of angles 0°, 45° and 90° to the casting direction of the cellulose acylate film.

Although there is no particular restriction on an adhesive to be used for lamination, examples thereof include a PVA resin (including a PVA modified with an acetoacetyl group, a sulfonic acid group, a carboxyl group, and an oxyalkylene group) and an aqueous solution of a boron compound. Among them, a PVA resin is preferable. The thickness of the adhesive layer after drying is preferably 0.01 to 10 μm, and especially preferably 0.05 to 5 nm.

Examples of the structure of the laminate are as below.

a) A/P/A

b) A/P/B

c) A/P/T

d) B/P/B

e) B/P/T

wherein A stands for an unstretched film of the present invention, B for a stretched film of the present invention, T for a cellulose triacylate film (FUJITAC) and P for a polarizing layer. In the structures of a) and b), A and B may be of cellulose acylate of the same or different compositions. In the structures of d), B may be of cellulose acylate of the same or different compositions, as well as with the same or different stretching ratios. Further, if integrated in a liquid crystal display device, either layer may face a liquid crystal layer, however, in case of b) and e) B faces preferably a liquid crystal layer. By integration into a liquid crystal display device, usually a substrate including a liquid crystal layer is arranged between two polarizers, thereby a) to e) of the present invention and a conventional polarizer (T/P/T) may be freely combined for use. It is preferable, however, on the outermost film on the display of the liquid crystal display device to construct a transparent hard coat layer, an antiglare layer, an antireflection layer, etc. and those described hereinbelow may be used.

The higher light transmittance of the thus obtained polarizer is the more preferable, and the higher degree of polarization is the more preferable. The light transmittance of the polarizer at a wavelength of 550 nm is preferably in the range of 30 to 50%, more preferably in the range of 35 to 50%, and further preferably in the range of 40 to 50%. The degree of polarization for light with a wavelength of 550 nm is preferably in the range of 90 to 100%, more preferably 95 to 100%, and most preferably, 99 to 100%.

By laminating the polarizer thus obtained with a λ/4 plate, circular polarization can be obtained. In this case, the two are laminated such that the slow axis of the λ/4 plate and the absorption axis of the polarizer contain an angle of 45°. Thereby, there is no particular restriction on the λ/4 plate, a λ/4 plate having such wavelength-dependent retardation is prefer able, that the retardation decreases as the wavelength decreases. Furthermore, a polarizing membrane having an absorption axis tilted by 20° to 70° relative to the longitudinal direction, and a λ/4 plate composed of an optically anisotropic layer composed of a liquid crystalline compound are preferably used.

A protective film may be bonded to one of the surfaces of the polarizer, and a separation film to the other surface. The protective film and the separation film are used in order to protect the polarizer when it is shipped or inspected, for example.

(ii) Optical Compensation Layer Forming (Formation of Optical Compensation Film)

An optically anisotropic layer works for compensating a liquid crystalline compound in a liquid crystal cell in displaying black by a liquid crystal display device, which is prepared by forming an orientation film on a stretched or unstretched cellulose acylate film and further adding an optically anisotropic layer thereto.

[Orientation Film]

An orientation film is formed on a stretched or unstretched cellulose acylate film which has been surface-treated as above. The orientation film has a function to regulate the orientation of liquid crystalline molecules. However, once the liquid crystalline molecules are oriented and then the orientation is solidified, the orientation film, which has completed the function, is not any more indispensable element of the present invention. In other word, only an optically anisotropic layer, which orientation has been solidified, existing on the orientation film may be transferred onto a polarizer to complete the polarizer of the present invention.

The orientation film can be formed by means of a rubbing treatment of an organic compound (preferably a polymer); oblique deposition of an inorganic compound; formation of a layer having micro grooves; or accumulation of an organic compound, such as ω-tricosanoic acid, dioctadecylmethylammonium chloride, and methyl stearate, by the Langmuir Brodgett method (LB membrane). Alternatively, an orientation film is known which acquires orienting function by applying an electric field or magnetic field, or light irradiation.

The orientation film is preferably formed by a rubbing treatment of a polymer. The polymer to be used for the orientation film has in principle a molecular structure functioning to orient liquid crystalline molecules.

In the present invention, the polymer preferably has, in addition to the function of orienting liquid crystalline molecules, a side chain having a crosslinkable functional group (e.g. a double bond) bound to the main chain, or a crosslinkable functional group capable of orienting a liquid crystalline molecule introduced in a side chain.

As the polymer to be used in the orientation film, both a self-crosslinkable polymer and a polymer crosslinkable by a cross-linking agent may be used, and further a plurality of combinations thereof may be used. Examples of the polymer include a methacrylate copolymer, a styrene copolymer, a polyolefin, a polyvinyl alcohol, a modified polyvinyl alcohol, poly(N-methylolacrylamide), a polyester, a polyimide, a vinyl acetate copolymer, a carboxymethylcellulose, and a polycarbonate, as described, for example, in Japanese Patent Application Laid-Open No. 08-338913 (DESCRIPTION, Paragraph [0022]). A silane coupling agent can be also used as a polymer. As the polymer is preferable a water-soluble polymer, such as poly(N-methylolacrylamide), a carboxymethylcellulose, gelatin, a polyvinyl alcohol and a modified polyvinyl alcohol; more preferable gelatin, a polyvinyl alcohol and a modified polyvinyl alcohol; and further preferable a polyvinyl alcohol and a modified polyvinyl alcohol. Particularly preferably, two types of polyvinyl alcohols or modified polyvinyl alcohols different in the degrees of polymerization are used in combination. The degree of saponification of polyvinyl alcohol is preferably 70 to 100%, and more preferably 80 to 100%. The degree of polymerization of a polyvinyl alcohol is preferably 100 to 5,000.

The side chain functioning to orient liquid crystalline molecules generally has a hydrophobic group as a functional group. The specific type of a functional group to be used is determined depending upon the type of liquid crystalline molecules and the desired orientation property. For example, a modification group for a modified polyvinyl alcohol may be introduced by a copolymerization modification, a chain transfer modification, or a block polymerization modification. Examples of the modification group include a hydrophilic group, such as a carboxylic acid group, a sulfonic acid group, a phosphonic acid group, an amino group, an ammonium group, an amide group, and a thiol group; a hydrocarbon group having 10 to 100 carbon atoms; a hydrocarbon group having a fluorine atom substituent; a thioether group; a polymerizable group such as an unsaturated polymerizable group, an epoxy group, an aziridinyl group; and an alkoxysilyl group such as trialkoxy, dialkoxy, and monoalkoxy. Specific examples of these modified polyvinyl alcohols are described in, for example, Japanese Patent Application Laid-Open No. 2000-155216 (DESCRIPTION, paragraphs [0022] to [0145]); and Japanese Patent Application Laid-Open No. 2002-62426 (DESCRIPTION, paragraphs [0018] to [0022]).

In case a side chain having a polymerizable functional group is bonded to the main chain of the orientation film polymer, or in case a crosslinkable function group is introduced into a side chain capable of orienting liquid crystalline molecules, the orientation film polymer and a multifunctional monomer contained in an optically anisotropic layer can be copolymerized. As a result, solid covalent bonds are formed not only between a multifunctional monomer and a multifunction monomer, but also between an orientation film polymer and an orientation film polymer, as well as between a multifunctional monomer and an orientation film polymer. Accordingly, by introducing a crosslinkable functional group into an orientation film polymer, the strength of an optical compensation film can be remarkably improved.

The crosslinkable functional group of the orientation film polymer preferably contains a polymerizable group, similarly to a multifunctional monomer. Examples thereof are described in, for example, Japanese Patent Application Laid-Open No. 2000-155216 (DESCRIPTION, paragraphs [0080] to [0100]). The orientation film polymer can also be crosslinked with a crosslinking agent, in place of using the above described crosslinkable functional group.

Examples of a crosslinking agent include an aldehyde, an N-methylol compound, a dioxane derivative, a compound which functions by activating a carboxyl group, an activated vinyl compound, an activated halogen compound, isoxazole and dialdehyde starch. Two or more crosslinking agents may be used together. Specific examples of the crosslinking agent are described in, for example, Japanese Patent Application Laid-Open No. 2002-62426 (DESCRIPTION, paragraphs [0023] to [0024]). Highly reactive aldehyde, especially, glutaraldehyde is preferable.

The addition amount of the crosslinking agent is preferably 0.1 to 20 mass-% with respect to the polymer, and more preferably 0.5 to 15 mass-%. The amount of unreacted crosslinking agent remaining in an orientation film is preferably 1.0 mass-% or less, and more preferably 0.5 mass-% or less. By regulating as above, the orientation film acquires sufficient durability without causing reticulation, even if it is used in a liquid crystal display device for a long term and allowed to stand in a high-temperature and high-humidity atmosphere for a long time period.

An orientation film may be formed by coating a solution, which contains the polymer basically serving as an orientation film building material and a crosslinking agent, onto a transparent substrate, heating it to solid (crosslinked), and being subjected to a rubbing treatment. The crosslinking reaction may be carried out at any time after the coating onto the transparent substrate as described above. In case a water-soluble polymer such as polyvinyl alcohol is used as the orientation film forming material, a mixture solvent of water and an organic solvent (e.g. methanol) having an antifoaming function is preferably used for the coating solution. The ratio of water to methanol is preferably 0/100 to 99/1 by mass, and more preferably 0/100 to 91/9. According to the above, foaming is inhibited and defects in the surfaces of the orientation film as well as the optically anisotropic layer can be reduced remarkably.

Preferable examples of a coating method for the orientation film include a spin coating method, a dip coating method, a curtain coating method, an extrusion coating method, a rod coating method and a roll coating method. Among them, the rod coating method is particularly preferable. The thickness of the film after drying is preferably 0.1 to 10 μm. The drying by heating may be carried out at 20° C. to 110° C. For adequate crosslinking, the temperature of 60° C. to 100° C. is preferable, and particularly preferable 80° C. to 100° C. The drying time may be 1 min to 36 hours, and preferably 1 min to 30 min. The pH of is preferably selected optimally depending upon the crosslinking agent to be used. In case glutaraldehyde is used, the pH is preferably 4.5 to 5.5, and further preferably about 5.

The orientation film is formed on a stretched or unstretched cellulose acylate film or on the primer layer. The orientation film is obtained by conducting a rubbing treatment on the surface of the polymer layer closslinked as describe above.

As the rubbing treatment, a rubbing method widely used in a liquid crystal orientation treatment process section for a liquid crystal display may be used. More specifically a method for orienting by rubbing the surface of an orientation film in a constant direction with paper, gauze, felt, rubber, nylon fibers or polyester fibers may be used. In general, a film is rubbed several times with a cloth flocked uniformly with fibers of uniform length and thickness.

Industrially, the rubbing is carried out by touching a rotating rubbing roll on a film with a polarizing layer while being conveyed. The circularity, cylindricity and deviation (eccentricity) of the rubbing roll are preferably less than 30 μm respectively. The wrap angle of the film on the rubbing roll is preferably 0.1 to 90°. However, as described in Japanese Patent Application Laid-Open No. 08-160430, a stable rubbing treatment can be also carried out by wrapping the film more than 360°. The film conveying speed is preferably 1 to 100 m/min. It is preferable to select an appropriate rubbing angle within the range of 0 to 60°. In case the film is used in a liquid crystal display device, the rubbing angle is preferably 40 to 50°, and further preferably 45°.

The thickness of the orientation film thus obtained is preferably in the range of 0.1 to 10 μm.

Next, the liquid crystalline molecules of an optically anisotropic layer are oriented on the orientation film. Thereafter, if necessary, the polymer of the orientation film is allowed to react with a multifunctional monomer contained in the optically anisotropic layer, or the polymer of the orientation film is crosslinked using a crosslinking agent.

Examples of the liquid crystalline molecule for use in the optically anisotropic layer include a rod-like liquid crystalline molecule and a discotic liquid crystalline molecule. The rod-like liquid crystalline molecule and the discotic liquid crystalline molecule may be a high molecular weight liquid crystalline molecule or a low molecular weight liquid crystalline molecule, and also include a low molecular weight liquid crystalline molecule, which is crosslinked and has lost the liquid crystalline feature.

[Rod-Like Liquid Crystalline Molecule]

Examples of a preferably usable rod-like liquid crystalline molecule include azomethines, azoxys, cyanobiphenyls, cyanophenyl esters, benzoic esters, cyclohexanecarboxylic acid phenyl esters, cyanophenyl cyclohexanes, cyano-substituted phenyl pyrimidines, alkoxy-substituted phenyl pyrimidines, phenyl dioxanes, tolanes and alkenyl cyclohexyl benzonitriles.

The rod-like liquid crystalline molecule includes a metal complex. Further, a liquid crystalline polymer containing a rod-like liquid crystalline molecule in a recurring unit may be used as a rod-like liquid crystalline molecule. In other words, the rod-like liquid crystalline molecule may be bonded to a (liquid crystalline) polymer.

Concerning rod-like liquid crystalline molecules, there are descriptions in Quarterly Review of Chemistry (Kikan Kagaku Sosetsu), vol. 22, “Chemistry of Liquid Crystal”, 1994, edited by the Chemical Society of Japan (Chapters 4, 7 and 11); and “Handbooks of Liquid Crystal Display Device” edited by the Japan Society for the Promotion of Science, the 142nd committee (Chapter 3).

The birefringence of a rod-like liquid crystalline molecule is preferably in the range of 0.001 to 0.7.

The rod-like liquid crystalline molecule preferably has a polymerizable group to fix the orientation. As the polymerizable group, a radical polymerizable unsaturated group or a cationic polymerizable group is preferable. Specific examples include polymerizable groups and polymerizable liquid crystalline compounds described in Japanese Patent Application Laid-Open No. 2002-62427 (DESCRIPTION, paragraphs to [0086]).

[Discotic Liquid Crystalline Molecule]

Examples of a discotic liquid crystalline molecule include benzene derivatives described in a research report by C. Destrade, et al. Mol. Cryst., vol. 71, p. 111 (1981); truxene derivatives described in research reports by C. Destrade, et al., MoI. Cryst., vol. 122, p. 141 (1985), and Physics Lett., A, vol. 78, p. 82 (1990); cyclohexane derivatives described in a research report by B. Kohne, et al. Angew. Chem., vol. 96, p. 70 (1984); and azacrown-based and phenylacetylene-based macrocycles described in research reports by J. M. Lehn, et al. (J. Chem. Commun., p. 1794 (1985) and J. Zhang, et al., J. Am. Chem. Soc., vol. 116, p. 2655 (1994).

The discotic liquid crystalline molecule includes a compound showing a liquid crystalline feature having a structure, in which a linear alkyl group, alkoxy group, or substituted benzoyloxy group is bonded radially as side chains to a core nucleus in the center of the molecule. The discotic liquid crystal molecule is preferably a molecule or a molecular aggregate having rotation symmetry and receptive capacity of certain orientation. In the optically anisotropic layer formed by a discotic liquid crystalline molecule, the compound contained in the completed optically anisotropic layer should not necessarily be a discotic liquid crystalline molecule. For example, such compound may be derived from a low molecular weight discotic liquid crystalline molecule with a group to be activated by heat or light, which may be polymerized or crosslinked by heat or light to a high molecular weight compound to lose the liquid crystalline feature. Some preferable examples of the discotic liquid crystalline molecule are described in Japanese Patent Application Laid-Open No. 08-50206. Furthermore, the polymerization of the discotic liquid crystalline molecule is described in Japanese Patent Application Laid-Open No. 08-27284.

To fix the discotic liquid crystalline molecule by polymerization, it is necessary to bond a polymerizable group as a substituent to the discotic core of the discotic liquid crystalline molecule. A preferable compound has the structure that the discotic core and the polymerizable group are connected via a linking group, by which the polymerization reaction proceeds maintaining the orientation. Examples of such compound are described in Japanese Patent Application Laid-Open No. 2000-155216 (DESCRIPTION, paragraphs [0151] to [0168]).

In a hybrid orientation, the angle contained between the major axis (disk plane) of the discotic liquid crystalline molecule and the plane of a polarizing membrane increases or decreases with an increase of the distance in the depth direction of an optically anisotropic layer from the polarizing membrane surface. This tilt angle preferably decreases with an increase of the distance. Further, the angle may include continuous increase, continuous decrease, intermittent increase, intermittent decrease, change including both continuous increase and continuous decrease, and intermittent change including increase and decrease. The intermittent change includes a region where the tilt angle does not change midway across the thickness. The angle should increase or decrease as a whole, allowing a constant region. However, the angle should preferably change continuously.

The average direction of the major axes of discotic liquid crystalline molecules on the side of a polarizing membrane can be controlled generally by selecting a discotic liquid crystalline molecule or a material for the orientation layer, or by selecting a rubbing method. On the other hand, the direction of the major axes (disk plane) of discotic liquid crystalline molecules on the surface side (open air side) can be controlled generally by selecting a discotic liquid crystalline molecule or a type of an additive to be used therewith. Examples of the additive to be used together with the discotic liquid crystalline molecule include a plasticizer, a surfactant, a polymerizable monomer and a polymer. The degree of fluctuation in the direction of the orientation of the major axis can be controlled similarly by selecting the liquid crystalline molecule and additive(s).

[Other Components for Optically Anisotropic Layer]

By mixing a plasticizer, a surfactant, a polymerizable monomer, etc. with the liquid crystalline molecule, the homogeneity and strength of the coated film or the orientation of the liquid crystalline molecule can be improved. The additives should preferably have good compatibility with the liquid crystalline molecule, and be able to modify the tilt angle of the liquid crystalline molecule, or not to inhibit the orientation thereof.

As a polymerizabie monomer, a radical polymerizable compound or a cationic polymerizable compound may be exemplified. A preferable compound is a multifunctional radical polymerizable monomer, which is copolymerizable with a liquid crystalline compound containing the above-described polymerizable group. Specific examples thereof are described in Japanese Patent Application Laid-Open No. 2002-296423 (DESCRIPTION, paragraphs [0018] to [0020]). The addition amount of the compound is generally in the range of 1 to 50 mass-% with respect to the discotic liquid crystalline molecule, and preferably in the range of 5 to 30 mass-%.

As the surfactant, publicly known compounds may be exemplified, and among others, a fluorine compound is preferable. Specific examples thereof are the compounds described in Japanese Patent Application Laid-Open No. 2001-330725 (DESCRIPTION, paragraphs [0028] to [0056]).

A polymer to be used together with a discotic liquid crystalline molecule should preferably be able to modify the tilt angle of the discotic liquid crystalline molecule.

As an example of the polymer, a cellulose ester may be exemplified. Preferable examples of a cellulose ester are described in Japanese Patent Application Laid-Open No. 2000-155216 (DESCRIPTION, paragraph [0178]). The addition amount of the polymer is preferably in the range of 0.1 to 10 mass-% with respect to the liquid crystalline molecule, and more preferably in the range of 0.1 to 8 mass-%, so that the orientation of the liquid crystalline molecule be not inhibited.

The transition temperature of a discotic liquid crystalline molecule between a discotic nematic liquid crystal phase and a solid phase is preferably 70 to 300° C., and more preferably 70 to 170° C.

[Formation of Optically Anisotropic Layer]

An optically anisotropic layer is formed by applying a coating solution containing a liquid crystalline molecule, and, if necessary, a polymerization initiator (described hereinbelow) or other arbitrary components, onto an orientation layer.

An organic solvent is preferably used to prepare the coating solution. Examples of the organic solvent include an amide such as N,N-dimethylformamide; a sulfoxide such as dimethylsulfoxide; a heterocyclic compound such as pyridine; a hydrocarbon such as benzene and hexane; an alkylhalide such as chloroform, dichloromethane and tetrachloroethane; an ester such as methyl acetate and butyl acetate; a ketone such as acetone and methylethyl ketone; and an ether such as tetrahydrofuran and 1,2-dimethoxyethane. Among them, an alkylhalide and a ketone are preferable. Two or more types of organic solvents may be used in combination.

The coating solution may be applied by a publicly known method, such as a wire-bar coating method, an extrusion coating method, a direct-gravure coating method, a reverse gravure coating method, and a die-coating method.

The thickness of the optically anisotropic layer is preferably 0.1 to 20 μm, more preferably 0.5 to 15 μm, and further preferably 1 to 10 μm.

[Fixation of Orientation State of Liquid Crystalline Molecule]

The oriented liquid crystalline molecules can be fixed maintaining the orientation state thereof. The fixation is preferably performed by a polymerization reaction. The polymerization reaction includes a thermal polymerization reaction using a thermal polymerization initiator and a photopolymerization reaction using a photopolymerization initiator. The photopolymerization reaction is preferable.

Examples of a photopolymerization initiator include an α-carbonyl compound (described in the specifications of U.S. Pat. Nos. 2,367,661 and 2,367,670); an acyloin ether (described in the specification of U.S. Pat. No. 2,448,828); an α-hydrocarbon-substituted aromatic acyloin ether (described in the specification of U.S. Pat. No. 2,722,512); a polynuclear quinone compound (described in the specifications of U.S. Pat. Nos. 3,046,127 and 2,951,758); a combination of triarylimidazole dimer and p-aminophenyl ketone (described in the specification of U.S. Pat. No. 3,549,367); a acridine and phenazine compound (described in the specifications of Japanese Patent Application Laid-Open No. 60-105667, U.S. Pat. No. 4,239,850); and an oxadiazole compound (described in the specification of U.S. Pat. No. 4,212,970).

The usage of the photopolymerization initiator is preferably in the range of 0.01 to 20 mass-% with respect to the solid content of the coating solution, and more preferably in the range of 0.5 to 5 mass-%.

UV rays are preferable for the photoirradiation to polymerize a liquid crystalline molecule.

The irradiation energy is preferably in the range of 20 mJ/cm² to 50 J/cm², more preferably in the range of 20 to 5,000 mJ/cm², and further preferably in the range of 100 to 800 mJ/cm². To accelerate the photopolymerization reaction, light may be irradiated under heating.

A protective layer may be formed on the optically anisotropic layer.

It is also preferable to combine the optical compensation film and the polarizing is formed. More specifically, a coating solution for the optically anisotropic layer as described above is applied onto the surface of the polarizing layer to form an optically anisotropic layer. As a result, since a polymer film is not used between the polarizing layer and the optically anisotropic layer, a thin-thickness polarizer with reduced stress (strain×cross-section×elastic modulus) to be generated by dimensional change of the polarizing layer is formed. Integrating the polarizer of the present invention into a large-size liquid crystal display device, the image of high display quality without the problem of light leakage can be obtained.

Stretching is preferably so conducted that the tilt angle between the polarizing layer and the optical compensation layer should conform with the angle between transmission axes of two polarizers, which are adhered to both sides of a liquid crystal cell constituting an LCD, and the longitudinal or transverse direction of the liquid crystal cell. The tilt angle is generally 45°. However, transmission type, reflection type and semi-transmission type LCD devices with the tilt angle other than 45° have been developed recently. Consequently, it is preferable that the stretching direction can be adjusted flexibly in accordance with the design of an LCD.

[Liquid Crystal Display Device]

Various liquid crystal modes using such optical compensation film will be explained below.

(TN Mode Liquid Crystal Display Device)

The TN mode liquid crystal display device is most frequently used as a color TFT liquid crystal display device, and described in many documents. In the orientation state of a liquid crystal cell of the TN mode at black display, rod-like liquid crystalline molecules rise in the middle of the cell, whereas rod-like liquid crystalline molecules are in the lying orientation state near the cell substrate.

(OCB Mode Liquid Crystal Display Device)

This uses a liquid crystal cell of a bend orientation mode, in which rod-like liquid crystalline molecules are oriented in substantially reverse directions

(symmetrically) at the upper part and lower part of the liquid crystal cell. A liquid crystal display device using a bend orientation mode liquid crystal cell is disclosed in the specifications of U.S. Pat. Nos. 4,583,825 and 5,410,422. Since the rod-like liquid crystalline molecules are oriented symmetrically at the upper and lower parts of the liquid crystal cell, the bend orientation mode liquid crystal cell has a self-optical-compensation function. Consequently, this liquid crystal mode is also referred to called as the OCB (optically compensatory bend) liquid crystal mode.

In the OCB mode liquid crystal cell, as in the case of the TN mode, in case of the orientation state for black display, rod-like liquid crystalline molecules rise in the center of the cell, whereas they are in the lying orientation state near the cell substrate.

(VA Mode Liquid Crystal Display Device)

The VA mode liquid crystal display device is characterized in that rod-like liquid crystalline molecules are oriented substantially vertically when no voltage is applied. Examples of the VA mode liquid crystal cell include (1) a VA mode liquid crystal cell in a narrow sense, in which rod-like liquid crystalline molecules are oriented substantially vertically without voltage application, and orient substantially horizontally with voltage application (described in Japanese Patent Application Laid-Open No. 02-176625); (2) an MVA mode liquid crystal cell, in which the VA mode is divided into multi-domains in order to enlarge the viewing angle (described in Proceeding of SID97, Digest of Tech. Papers 28 (1997), 845); (3) an n-ASM mode liquid crystal cell, in which rod-like liquid crystalline molecules are oriented substantially vertically without voltage application, and turned to twisted multi-domain orientation with voltage application (Proceeding of Japanese liquid crystal symposium (1998), p. 58-59); and (4) a SURVAIVAL mode liquid crystal cell (publicated in LCD International '98).

(IPS Mode Liquid Crystal Display Device)

The IPS mode liquid crystal display device is characterized in that rod-like liquid crystalline molecules are oriented substantially horizontally in a plane without voltage application. The orientation of the liquid crystalline molecules is changed by voltage application functioning as a switch. Specific usable examples thereof are described in Japanese Patent Application Laid-Open Nos. 2004-365941; 2004-12731, 2004-215620, 2002-221726, 2002-55341 and 2003-195333.

(Other Liquid Crystal Display Devices)

Optical compensation can be performed according to a similar concept as above for the ECB and STN (Supper Twisted Nematic) mode, the FLC (Ferroelectric Liquid Crystal) mode, the AFLC (Anti-ferroelectric Liquid Crystal) mode, and the ASM (Axially Symmetric Aligned Microcell) mode. Furthermore, the cells can be applicable to liquid crystal display devices of any of a transmission type, a reflective type and a semi-transmission type. The same can be also favorably utilized as an optical compensation sheet for a reflective type liquid crystal display device of GH (Guest-Host) type.

These uses of the cellulose derivative film mentioned above are described in details in Technical Report No. 2001-1745, published on 15 Mar. 2001 by the Japan Institution of Invention and Innovation, p. 45 to 59.

[Formation of Anti-Reflective Layer (Anti-Reflective Film)]

The anti-reflective film is generally constructed by forming a low refractive index layer, serving also as an antifouling layer, and at least one layer having a higher refractive index than that of the low refractive index layer (i.e. a high refractive index layer or a medium refractive index layer) on a transparent substrate.

An example of a method for forming the anti-reflective film is to form a multi-layered film by laminating transparent membranes of inorganic compounds (e.g. metal oxides) having different refractive indices, and form thereon a coat layer of colloidal metal oxide particles by a chemical vapor deposition (CVD) method, a physical vapor deposition (PVD) method, or a sol-gel technique from a metal compound such as a metal alkoxide, which is then subjected to an aftertreatment (UV ray irradiation: Japanese Patent Application Laid-Open No. 09-157855; and plasma treatment: Japanese Patent Application Laid-Open No. 2002-327310).

On the other hand, as anti-reflective films having a high productivity, various types of anti-reflective films have been proposed, which are formed by coating multi-layers containing inorganic particles dispersed in the matrix.

There is an anti-reflective film comprising an anti-reflective layer having an anti-glare property, which is conferred by minute roughening of the top surface of the anti-reflective film formed by coating as above.

A cellulose acylate film of the present invention is applicable to any of the above methods, but the coating method (coating type) is especially preferable.

[Layer Structure of Coating Type Anti-Reflective Film]

The anti-reflective film having the layer structure constituted at least of a medium refractive index layer, a high refractive index layer and a low refractive index layer (outermost layer) on a substrate in the mentioned order should be designed to have refractive indices satisfying the following relationships.

The refractive index of the high refractive index layer>the refractive index of the medium refractive index layer>the refractive index of the transparent substrate>the refractive index of the low refractive index layer. Furthermore, a hard-coat layer may be provided between the transparent substrate and the medium refractive index layer.

The anti-reflective film may be constituted of a medium refractive index hard coat layer, a high refractive index layer and a low refractive index layer

Examples thereof are described in Japanese Patent Application Laid-Open Nos. 08-122504, 08-110401, 10-300902, 2002-243906 and 2000-111706. Furthermore, other function may be added to each of the layers. For example, a low refractive index layer having an anti-fouling function, and a high refractive index layer having an anti-static function may be exemplified (e.g., Japanese Patent Application Laid-Open Nos. 10-206603 and 2002-243906).

The haze of the anti-reflective film is preferably 5% or less, and more preferably 3% or less. The strength of the film is preferably “H” or harder based on the pencil hardness test according to JIS K5400, more preferably “2H” or harder, and further preferably, “3H” or harder.

[High Refractive Index Layer and Medium Refractive Index Layer]

The high refractive index layer of the anti-reflective film is constituted of a curable film containing at least ultra-fine inorganic particles with the average particle size of 100 nm or less and a high refractive index and a matrix binder.

As the ultra-fine inorganic particles with a high refractive index, there are exemplified inorganic compounds having a refractive index of 1.65 or higher, and preferably those having a refractive index of 1.9 or higher. Examples thereof include oxides of Ti, Zn, Sb, Sn, Zr, Ce, Ta, La and In, and composite oxides containing these metal atoms.

Such ultra-fine particles are prepared for example by: treating the particle surface by a surface treatment agent (e.g. by a silane coupling agents: Japanese Patent Application Laid-Open Nos. 11-295503, 11-153703, and 2000-9908; by an anionic compound or an organo-metal coupling agent: Japanese Patent Application Laid-Open No. 2001-310432); forming a core-shell structure with a high refractive index particle as a core (e.g. Japanese Patent Application Laid-Open No. 2001-166104); and using a specific dispersion agent in combination (e.g. Japanese Patent Application Laid-Open Nos. 11-153703 and 2002-2776069, and U.S. Pat. No. 6,210,858 B1).

As a material for forming a matrix, a thermoplastic resin and a thermosetting resin film known publicly can be exemplified.

Furthermore, as a material for a matrix, at least one composition selected from a composition containing a multifunctional compound with at least 2 radical and/or cationic polymerizable groups, a composition containing an organo-metallic compound with a hydrolysable group and partial condensation products thereof is preferable. Examples thereof include the compounds described in Japanese Patent Application Laid-Open Nos. 2000-47004, 2001-315242, 2001-31871, and 2001-296401.

Furthermore, a curable film obtained from a colloidal metal oxide, which is obtained from a hydrolytic condensation product of a metal alkoxide, and a metal alkoxide composition is also a preferable material. Such a material is described for example in Japanese Patent Application Laid-Open No. 2001-293818.

The refractive index of the high refractive index layer is generally 1.70 to 2.20. The thickness of the high refractive index layer is preferably 5 nm to 10 μm, and more preferably 10 nm to 1 μm.

The refractive index of the medium refractive index layer is adjusted so as to fall between the refractive indices of the low refractive index layer and the high refractive index layer. The refractive index of the medium refractive index layer is preferably 1.50 to 1.70.

[Low Refractive Index Layer]

The low refractive index layer is formed sequentially by lamination on the high refractive index layer. The refractive index of the low refractive index layer is 1.20 to 1.55, and preferably 1.30 to 1.50.

The low refractive index layer is preferably formed as the outermost layer having anti-scratch property and anti-fouling property. To improve substantially the anti-scratch property, it is effective to confer a slipping property to the surface, which can be realized by a publicly known means, such as introduction of silicone or fluorine into a film.

The refractive index of a fluorine-containing compound is preferably 1.35 to 1.50, and more preferably 1.36 to 1.47. The fluorine-containing compound is preferably a compound containing a fluorine atom in the range of 35 to 80 mass-% and additionally a crosslinkable or polymerizable functional group.

Examples of the fluorine-containing compound are described for example in Japanese Patent Application Laid-Open Nos. 09-222503 (DESCRIPTION, paragraphs to [0026]), 11-38202 (DESCRIPTION, paragraphs [0019] to [0030]), 2001-40284 (DESCRIPTION, paragraphs [0027] to [0028]) and 2000-284102.

As a silicone compound, a compound which has a polysiloxane structure, having in its polymer chain a curable or polymerizable functional group, and forms a crosslinked structure in the film is preferable. Examples thereof include a reactive silicone (e.g. Silaplane (trade name), Chisso Corporation) and a polysiloxane having silanol groups at both the ends (Japanese Patent Application Laid-Open No. 11-258403).

The crosslinking or polymerization reaction of a fluorine containing polymer and/or a siloxane polymer, having crosslinkable or polymerizable groups is preferably conducted by light irradiation or heating, simultaneously with or after the application of a coating composition for forming the outermost layer, containing a polymerization initiator or a sensitizer.

As the low refractive index layer, a sol-gel curable film is also preferable, which is cured in the presence of a catalyst by the condensation reaction between an organo-metallic compound, such as a silane coupling agent, and a silane coupling agent containing a certain fluorine-containing hydrocarbon group.

Examples of such compound include a silane compound containing a polyfluoroalkyl group or partial hydrolytic condensation products thereof (described in Japanese Patent Application Laid-Open Nos. 58-142958, 58-147483, 58-147484, 09-157582, and 11-106704), and a silyl compound containing a polyperfluoroalkyl ether group, which is a fluorine-containing long-chain group (described in Japanese Patent Application Laid-Open Nos. 2000-117902, 2001-48590, and 2002-53804).

The low refractive index layer may contain, in addition to the aforementioned additives, a filler, such as a low refractive index inorganic compound whose average primary particle size is 1 to 150 nm [e.g. a silicon dioxide (silica) and fluorine-containing particles (magnesium fluoride, calcium fluoride and barium fluoride)], and organic fine particles (described in Japanese Patent Application Laid-Open No. 11-3820, DESCRIPTION, paragraphs [0020] to [0038]); a silane coupling agent; a slipping agent; a surfactant, and the like.

In case the low refractive index layer is formed underneath the outermost layer, the low refractive index layer may be formed by a vapor phase method, such as a vacuum deposition method, a sputtering method, an ion plating method, and a plasma CVD method. In view of the low production cost, a coating method is preferable.

The thickness of the low refractive index layer is preferably 30 to 200 nm, more preferably 50 to 150 nm, and further preferably 60 to 120 nm.

[Hard Coat Layer]

A hard coat layer is provided on the surface of a stretched or unstretched cellulose acylate film to confer physical strength to the anti-reflective film. In particular, the hard coat layer is preferably provided between the stretched or unstretched cellulose acylate film and the high refractive index layer. It is also preferable to coat the hard coat directly on the stretched or unstretched cellulose acylate film without providing the anti-reflective layer.

The hard coat layer is preferably formed by a crosslinking reaction or a polymerization reaction of a photo- and/or thermocuring compound. As a curing functional group, a photo-polymerizable functional group is preferable. Furthermore, as an organometallic compound containing a hydrolysable functional group, an organic alkoxysilyl compound is preferable.

Specific examples of these compounds include those exemplified for the high refractive index layer.

Specific examples of compositions for the hard coat layer are described in Japanese Patent Application Laid-Open Nos. 2002-144913 and 2000-9908, and WO00/46617.

The high refractive index layer can function as a hard coat layer as well. In this case, the layer is preferably formed by dispersing fine particles finely in the hard coat layer according to the technique described for the high refractive index layer.

The hard coat layer can function also as an anti-glare layer (described hereinbelow) by adding particles with the average particle size of 0.2 to 10 μm to confer the anti-glare function.

The thickness of the hard coat layer may be appropriately designed depending on the use. The thickness of the hard coat layer is preferably 0.2 to 10 μm, and more preferably 0.5 to 7 μm.

The strength of the hard coat layer is preferably “H” or harder based on the pencil hardness test according to JIS K₅₄₀₀, more preferably “2H” or harder, and further preferably “3H” or harder. Also) the abrasion of a specimen through a Taber abrasion test according to JIS K5400 should be preferably as low as possible.

[Front Scattering Layer]

The front scatting layer works, when mounted to a liquid crystal display device, to confer the viewing angle improving effect for cases the viewing angle is tilted variously (up and down, right and left). A hard coat layer can serve as a front scatting layer, if fine particles having different refractive indices are dispersed in the hard coat layer.

Examples thereof include those specifying the front scatting coefficient described in Japanese Patent Application Laid-Open No. 11-38208, those specifying the range of the relative refractive indices of a transparent resin and fine particles described in Japanese Patent Application Laid-Open No. 2000-199809, and those specifying the haze at 40% or higher described in Japanese Patent Application Laid-Open No. 2002-107512.

[Other Layers]

In addition to the aforementioned layers, a primer layer, an antistatic layer, an undercoating layer, and a protective layer may be provided.

[Coating Method]

Individual layers of the anti-reflective film may be formed by a coating method, such as a dip-coating method, an air-knife coating method, a curtain coating method, a roll coating method, a wire-bar coating method, a gravure coating method, a micro-gravure coating method and an extrusion coating method (U.S. Pat. No. 2,681,294).

[Anti-Glare Function]

The anti-reflective film may have an anti-glare function to scatter the external light. The anti-glare function can be attained by forming ruggedness on the surface of the anti-reflective film. In case the anti-reflective film has an anti-glare function, the haze of the anti-reflective film is preferably 3 to 30%, more preferably 5 to 20%, and further preferably 7 to 20%.

As a method of forming ruggedness on the surface of the anti-reflective film, any method may be used insofar as it can sufficiently maintain such ruggedness. Examples thereof include a method to add fine particles to the low refractive index layer to form a rugged film surface (e.g. Japanese Patent Application Laid-Open No. 2000-271878); a method to add a small amount (0.1 to 50 mass-%) of relatively large particles (particle size of 0.05 to 2 μm) in the underlying layer of the low refractive index layer (i.e. a high refractive index layer, a medium refractive index layer or a hard coat layer) to create a rugged underlying layer, and to add the low refractive index layer thereon maintaining the ruggedness (e.g., Japanese Patent Application Laid-Open Nos. 2000-281410, 2000-95893, 2001-100004 and 2001-281407); and a method to transfer ruggedness physically onto the coated surface of the uppermost layer (an anti-fouling layer) by, for example, embossing (Japanese Patent Application Laid-Open Nos. 63-278839, 11-183710 and 2000-275401).

[Use]

The unstretched or stretched cellulose acylate film of the present invention is useful as an optical film, in particular, a protective film for a polarizer, an optical compensation sheet (AKA retardation film) for a liquid crystal display device, an optical compensation sheet for a reflective liquid crystal display device, and a substrate for a silver halide photographic photosensitive material.

The measuring methods used in the present invention will be described below.

(1) Elastic Modulus

A stress at 0.5% elongation was measured at a tensile speed of 10%/min in the atmosphere of 23° C., 70% RH to determine the elastic modulus. Thereby the average of the machine direction (MD) and the cross-machine direction (TD) values was employed as the elastic modulus.

(2) Substitution Degree of Cellulose Acylate

The substitution degrees of the respective acyl groups of a cellulose acylate and that of acyl groups at the 6-position were determined by a ¹³C-NMR method described by Tezuka, et al. (Carbohydr. Res. 273 (1995) p. 83-91).

(3) Residual Solvents 300 mg of a film sample was dissolved in 30 mL of methyl acetate to prepare Sample A, and in 30 mL of dichloromethane to prepare Sample B. These Samples were measured by gas chromatography (GC) under the following conditions:

Column: DB-WAX (0.25 mmφ×30 in, film thickness 0.25 μm)

Column temperature: 50° C.

Carrier gas: nitrogen

Analysis time: 15 min

Sample amount injected: 1 μml

The solvent quantity was determined according to the following method.

The contents of components in Sample A other than the solvent (methyl acetate) were determined from the respective peaks using calibration curves, and were summed up to Total Sa.

The contents of components in Sample B, which were in the region masked by the peak of the solvent in Sample A, were determined from the respective peaks using calibration curves, and were summed up to Total Sb. The total of Sa and Sb was defined as the quantity of the residual solvents.

(4) Loss on Heating at 220° C.

A sample (10 mg) was heated on TG-DTA2000S (MAC Science Corp.) in the nitrogen atmosphere from room temperature to 400° C. at a heating rate of 10° C./min and the weight loss rate at 220° C. was used as the loss on heating.

(5) Melt Viscosity

Measurement was conducted under the following conditions using a cone-plate viscoelasticity measuring instrument (e.g. Modular Compact Rheometer: Physica MCR301 by Anton Paar GmbH). Namely, a resin sample was dried well to the water content of 0.1% or less, and then measured with gap setting of 500 μm, at a temperature of 220° C. and a shear rate of 1 sec⁻¹.

(6) Re, Rth

Film samples were collected at 10 points at even intervals in the cross-machine direction of the film, and conditioned at 25° C., 60% RH for 4 hours. Retardations at the wave length of 590 nm were measured at 25° C., 60% RH by an automatic birefringence analyzer (KOBRA 21 ADH by Oji Scientific Instruments) with the incident light perpendicular to the surface of the film specimen, and changing the incident angle from +50° to −50° at 10° intervals relative to the normal line of the film tilting around the slow axis as the rotation axis. The in-plane retardation (Re) and the thickness-direction retardation (Rth) were calculated from the measurements.

The features of the present invention will be described in more detail by means of Examples and Comparative Examples, provided that the materials, quantities used, contents, treatments, procedures, etc. described in Examples may be freely changed without departing from the spirit of the present invention. Consequently, the scope of the present invention should not be interpreted in any restrictive way by reason of the following Examples.

### EXAMPLES

(1) Formation of Cellulosic Resin Film

A cellulosic resin (CAP-482-20, the number average molecular weight: 70,000) was extruded by a single screw extruder (GM Engineering, Cylinder inner diameter D: 90 mm) at the extrusion temperature of 240° C. and the extrusion speed 5 m/min to a film of the thickness 100 μm. The film was trimmed at both the edges (each 3% of the total width) just before the winding and subjected to knurling of 10 mm width and 50 μm height at both the edges. Other conditions are described below.

### Example 1

A resin sheet extruded through the die at 240° C. was heated by a heater, whose temperature could be regulated in the cross-machine direction, and then formed to a film by a casting drum method. The resin sheet and the heater were sheathed by a cover. The length of the melt resin was set at 80 mm. Thereby the heater was a far-infrared heater, the width thereof was 1.2-fold the die lip width, and the heating length thereof in the machine direction of the resin sheet was 70% of the resin sheet length. The material used for the cover was aluminum.

### Example 2

The film was formed under the identical conditions as Example 1, except that the cover was not used.

### Example 3

The film was formed under the identical conditions as Example 1, except that the cover was not used and the temperature regulation in the cross-machine direction was not conducted.

### Example 4

The film was formed under the identical conditions as Example 3, except that the heating length of the heater in the machine direction of the resin sheet was 50% of the resin sheet length.

### Example 5

The film was formed under the identical conditions as Example 3, except that the heating length of the heater in the machine direction of the resin sheet was 20% of the resin sheet length.

### Example 6

The film was formed under the identical conditions as Example 5, except that the heater width was 1.0-fold the die lip width.

### Example 7

The film was formed under the identical conditions as Example 3, except that the resin sheet length was 30 mm.

### Example 8

The film was formed under the identical conditions as Example 3, except that the resin sheet length was 130 mm.

### Example 9

The film was formed under the identical conditions as Example 3, except that the resin sheet length was 180 mm.

### Comparative Example 1

The film was formed under the identical conditions as Example 5, except that the heating length of the heater in the machine direction of the resin sheet was 10% of the resin sheet length.

### Comparative Example 2

The film was formed under the identical conditions as Example 5, except that the heater width was 0.7-fold the die lip width.

### Comparative Example 3

The film was formed under the identical conditions as Example 1, except that the heater and the cover were not used.

### Comparative Example 4

The film was formed under the identical conditions as Example 3, except that the resin sheet length was 230 mm.

(2) Evaluation of Film Formed by Melt-Casting (Unstretched)

(i) Thickness Unevenness

The thickness was measured at a pitch of 1 mm by an off-line contact type continuous thickness measuring apparatus (TOF-VI, by Yamabun Electronics Co.). Thereby in the cross-machine direction the whole width of the film after trimming, and in the machine direction a 3 m range were measured. The evaluation was expressed in a rating scale of VG: very good, G: good, P: poor, and VP: very poor. More particularly, with respect to the machine direction and the cross-machine direction respectively, the rating was given according to: VG if the thickness unevenness was 1.0 μm or less, G if the thickness unevenness was beyond 1.0 μm and equal to or less than 5.0 μm, P if the thickness unevenness was beyond 5.0 μm and equal to or less than 10 μm, and VP if the thickness unevenness was beyond 10 μm.

(ii) Temperature difference in the cross-machine direction and temperature decrease in the machine direction

Measurements were conducted using AGEMA Thermovision CPA570 (by Chino Corp.). The temperature difference in the cross-machine direction and the temperature decrease in the machine direction were evaluated by the respective maximum values.

As obvious from FIG. 11, the films were formed in Examples 1 to 9 by keeping the temperature difference of the resin sheet in the cross-machine direction from departing the die to touching the casting drum within 10° C., the thickness unevenness in the cross-machine direction and the thickness unevenness in the machine direction were suppressed. On the other hand, in Comparative Examples 1 to 4, the temperature difference of the resin sheet in the cross-machine direction from departing the die to touching the casting drum exceeded 10° C., and the thickness unevenness in the cross-machine direction and the thickness unevenness in the machine direction could not be suppressed.

Seeing in more detail, Examples 3 to 5 and Comparative Example 1 were carried out under the same conditions, except that the heating distance of the heater in the machine direction of the resin sheet (the distance between the uppermost edge and the lowermost edge of the heater) were 70%, 50%, 20% and 10% respectively of the length of the resin sheet. Only in Comparative Example 1 with the heating distance of 10%, the temperature difference in the cross-machine direction exceeded 10° C., and the thickness unevenness in the cross-machine direction was VP. This shows that the heating distance of the heater in the machine direction of the resin sheet should be preferably 20% or more of the length of the resin sheet in the machine direction. Further, from Examples 7 to 9 and Comparative Example 3, it is obvious that by limiting the length of the resin sheet in the machine direction from departing the die to touching the casting drum within 200 mm, the temperature difference of the resin sheet in the cross-machine direction can be within 10° C. so that the thickness unevenness of the film can be suppressed. In Comparative Example 2, the heater width was 0.7-fold, and some parts of the resin sheet were not heated, so that the temperature difference in the cross-machine direction was worsened.

From Examples 2 and 3, it is obvious that the regulation of the temperature in the cross-machine direction can reduce the thickness unevenness in the cross-machine direction. Further, from Examples 1 and 2, it is obvious that sheathing the heater by the aluminum cover can reduce the temperature difference in the cross-machine direction and the temperature decrease in the machine direction, and therefore that sheathing the heater by a cover having a heat insulating function and/or a heat reflecting function is preferable.

(3) Preparation of Polarizer

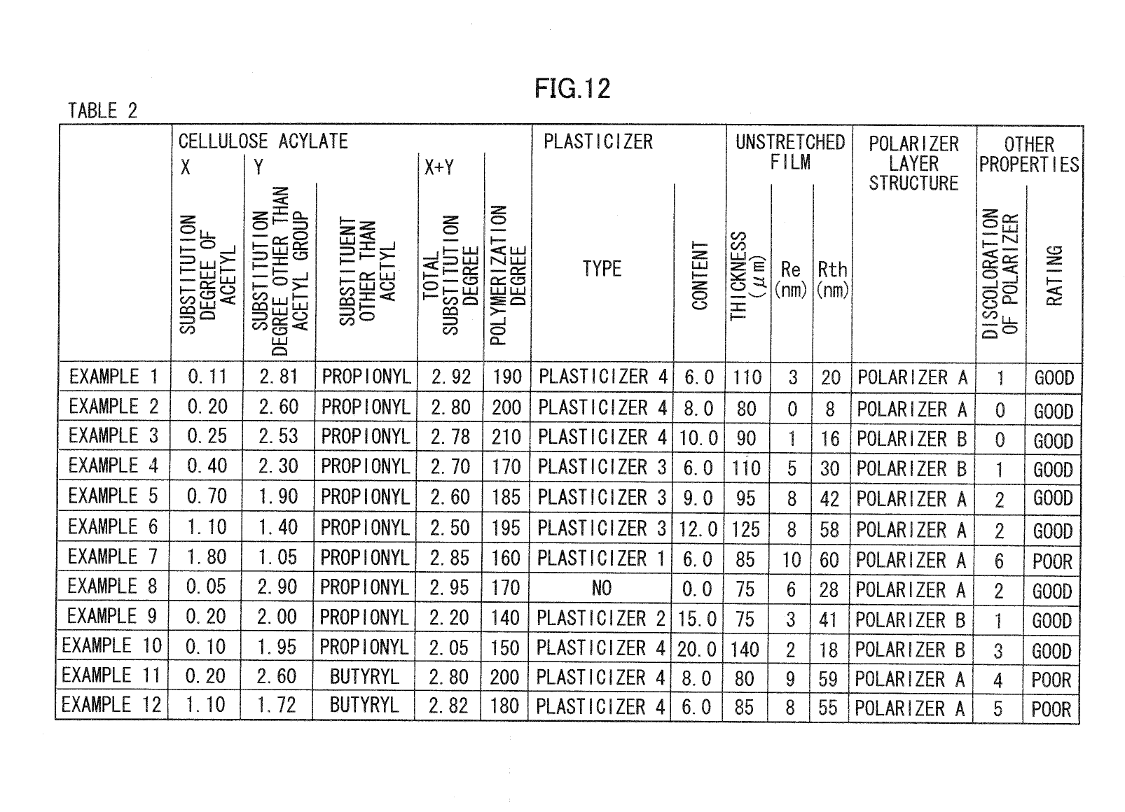

The following polarizers were prepared by producing unstretched films using the various film materials (degree of substitution, degree of polymerization and plasticizer) described in Table 2 in FIG. 12 according to the film formation conditions of Example 1 (deemed as the best mode) of FIG. 11.

(3-1) Saponification of Cellulosic Resin Film

An unstretched cellulosic resin film was saponified by the following dipping saponification method. A substantially identical result was obtained by the following coating saponification method.

(i) Coating Saponification Method

To 80 parts by mass of isopropanol was added 20 parts by mass of water, in which KOH was dissolved to 2.5N. The mixture was adjusted to 60° C. and used as a saponification solution. The solution was coated on the 60° C. cellulosic resin film to the thickness of 10 g/m² to saponify the film for 1 min. Then 50° C.-warm water was sprayed at a rate of 10 L/(m²·min) for 1 min to wash the surface.

(ii) Dipping Saponification Method

An aqueous 2.5N NaOH solution was used as a saponification solution. The solution was adjusted to 60° C., in which a cellulosic resin film was dipped for 2 min. Then the film was dipped in a 0.1N aqueous solution of sulfuric acid for 30 sec, and then passed through a water bath.

(3-2) Preparation of Polarizing Layer

The film was stretched in the machine direction by generating the circumferential velocity difference between the 2 pairs of nipping rolls according to the example 1 of Japanese Patent Application Laid-Open No. 2001-141926, to prepare a polarizing layer with the thickness of 20 μm.

(3-3) Lamination

The thus obtained polarizing layer, the unstretched cellulosic resin film saponified as above, and a saponified FUJITAC (unstretched triacylate film) were laminated using a 3% aqueous solution of PVA (PVA-117H by Kuraray Co. Ltd.) as an adhesive, aligning the stretching direction of the polarizing layer along the machine direction of the cellulosic resin film according to the following combinations.

Polarizer A: unstretched cellulosic resin film/polarizing layer/FUJITAC
Polarizer B: unstretched cellulosic resin film/polarizing layer/unstretched cellulosic resin film

(3-4) Discoloration of Polarizer

The degree of the discoloration of the thus obtained polarizer was evaluated and expressed in a 10-scale rating (higher rating represents stronger discoloration). All of the polarizers prepared according to the present invention were evaluated as good.

(3-5) Evaluation of Humidity Curling

The thus obtained polarizers were measured according to the aforedescribed method. The polarizers prepared by exercising the present invention showed good properties (low humidity curling).

Additionally, the cellulosic resin film was so laminated that its machine direction and the polarization axis of the polarizer contain 90° or 45°, and the same evaluations were conducted. Both of them gave the same results as the parallel laminates.

(4) Preparation of Optical Compensation Film and Liquid Crystal Display Element

From a 22-inch liquid crystal display device (Sharp Corp.) using a VA mode liquid crystal cell, a viewer-side polarizer was removed and in exchange the retardation polarizer A or B was laminated on the viewer side in the above LCD by means of an adhesive so that the cellulosic resin film is on the viewer side of the liquid crystal cell. Thereby a liquid crystal display was prepared by arranging the polarizer, so that the transmission axis of the viewer-side polarizer and that of the backlight-side polarizer crossed at right angle.

Thereby accurate positioning in bonding was possible owing to easy laminating property by reason of little humidity curling.

Further, by using the cellulosic resin film of the present invention, instead of the cellulosic resin film coated with a liquid crystal layer as described in the example 1 of Japanese Patent Application Laid-Open No. 11-316378, a good optical compensation filter film exhibiting little humidity curling could be prepared.

By replacing the cellulosic resin film coated with a liquid crystal layer as described in the example 1 of Japanese Patent Application Laid-Open No. 07-333433 with the cellulosic resin film of the present invention for preparation of an optical compensation filter film, a good optical compensation film exhibiting little humidity curling could be prepared.

Further, by using the polarizer and the retardation polarizer of the present invention for the liquid crystal display device described in the example 1 of Japanese Patent Application Laid-Open No. 10-48420; for the optically anisotropic layer containing the discotic liquid crystalline molecules described in the example 1 of Japanese Patent Application Laid-Open No. 09-26572; for an orientation layer coated with polyvinyl alcohol; for the 20-inch VA-mode liquid crystal display device described in the FIGS. 2 to 9 of Japanese Patent Application Laid-Open No. 2000-154261; for the 20-inch OCB-mode liquid crystal display device described in the FIGS. 10 to 15 of Japanese Patent Application Laid-Open No. 2000-154261; and for the IPS-mode liquid crystal display device described in the FIG. 11 of Japanese Patent Application Laid-Open No. 2004-12731, good liquid crystal display elements exhibiting little humidity curling were obtained.

(5) Preparation of Low Reflection Film

A low reflection film was prepared using the cellulosic resin film of the present invention in accordance with the example 47 in Journal of Technical Disclosure (Disclosure No. 2001-1745, published by the Japan Institute of Invention and Innovation). The humidity curling of the prepared film was measured by the above-described method. The film formed according to the present invention produced good results similarly as in the case of the polarizer.

The low reflection films of the present invention were laminated on the outermost surface of the liquid crystal display device described in the example 1 of Japanese Patent Application Laid-Open No. 10-48420; the 20-inch VA-mode liquid crystal display device described in the FIGS. 2 to 9 of Japanese Patent Application Laid-Open No. 2000-154261; the 20-inch OCB-mode liquid crystal display device described in the FIGS. 10 to 15 of Japanese Patent Application Laid-Open No. 2000-154261; and the IPS-mode liquid crystal display device described in the FIG. 11 of Japanese Patent Application Laid-Open No. 2004-12731, and evaluations thereof were conducted. Good quality liquid crystal display elements were obtained.

1. A process for producing a cellulosic resin film by extruding a molten resin molten in an extruder in a form of a sheet through a die onto a rotating chill roll to chill and solidify the resin forming a film, characterized in that the film is formed by keeping a temperature difference in a cross-machine direction of the resin sheet from departing the die to touching the chill roll within 10° C.

2. The process for producing a cellulosic resin film according to claim 1, characterized in that the film is formed by keeping a temperature decrease in a machine direction of the resin sheet from departing the die to touching the chill roll within 20° C.

3. The process for producing a cellulosic resin film according to claim 1, characterized in that at least one side of the resin sheet from departing the die to touching the chill roll is heated by a heating unit, wherein a heated length by the heating unit in the machine direction of the resin sheet is 20% or more of the machine direction length of the resin sheet from departing the die to touching the chill roll.

4. The process for producing a cellulosic resin film according to claim 3, characterized in that the machine direction length of the resin sheet from departing the die to touching the chill roll is 200 mm or shorter.

5. The process for producing a cellulosic resin film according to claim 3, characterized in that heating temperatures of the heating unit in the cross-machine direction of the resin sheet can be controlled.

6. The process for producing a cellulosic resin film according to claim 3, characterized in that the resin sheet and the heating unit are sheathed by a cover having a heat-insulation function and/or a heat-reflection function.

7. The process for producing a cellulosic resin film according to claim 1, characterized in that the resin sheet is nipped for chilling and solidifying to form a film between a pair of rolls, one of which is the chill roll and the other is an elastic roll.

8. A cellulosic resin film, characterized by being produced by the process for producing according to claim 1.

9. The process for producing a cellulosic resin film according to claim 2, characterized in that at least one side of the resin sheet from departing the die to touching the chill roll is heated by a heating unit, wherein a heated length by the heating unit in the machine direction of the resin sheet is 20% or more of the machine direction length of the resin sheet from departing the die to touching the chill roll.

10. The process for producing a cellulosic resin film according to claim 9, characterized in that the machine direction length of the resin sheet from departing the die to touching the chill roll is 200 mm or shorter.

11. The process for producing a cellulosic resin film according to claim 10, characterized in that heating temperatures of the heating unit in the cross-machine direction of the resin sheet can be controlled.

12. The process for producing a cellulosic resin film according to claim 11, characterized in that the resin sheet and the heating unit are sheathed by a cover having a heat-insulation function and/or a heat-reflection function.

13. The process for producing a cellulosic resin film according to claim 12, characterized in that the resin sheet is nipped for chilling and solidifying to form a film between a pair of rolls, one of which is the chill roll and the other is an elastic roll.
